(19) United States
(12) Patent Application Publication
(10) Pub. No.: US 2025/0139535 A1
(43) Pub. Date: May 1, 2025

(54) COMPUTING SYSTEM AND METHOD FOR RAPIDLY QUANTIFYING FEATURE INFLUENCE ON THE OUTPUT OF A DATA SCIENCE MODEL

(71) Applicant: Discover Financial Services, Riverwoods, IL (US)

(72) Inventors: Alexey Miroshnikov, Scottsdale, AZ (US); Khashayar Filom, Chicago, IL (US); Arjun Ravi Kannan, Buffalo Grove, IL (US); Konstandinos Kotsiopoulos, Easthampton, MA (US)

(21) Appl. No.: 18/815,524

(22) Filed: Aug. 26, 2024

Related U.S. Application Data
(63) Continuation-in-part of application No. 18/499,974, filed on Nov. 1, 2023.

(51) Int. Cl. G06N 20/20

(52) U.S. Cl. CPC G06N 20/20

(57) ABSTRACT

A computing platform is configured to (i) receive a request to compute a score for an input data record; (ii) partition a set of features into global feature groups; (iii) input a group of actual parameters associated with the features into a trained data science model comprising an ensemble of decision trees; (iv) for each tree in the ensemble, identify a respective leaf based on a comparison of the actual parameters to a series of splitting conditions for the respective leaf and determining respective individual contribution values for features for the respective leaf based on local feature groups corresponding to the global feature groups; (v) compute a respective overall feature contribution value for each individual feature; (vi) compute the score for the input data record; (vii) identify a reason code for the score; and (viii) transmit the score and the reason code in response to the request.

### CROSS-REFERENCE TO RELATED APPLICATIONS

The current application is a continuation in part of U.S. patent application Ser. No. 18/499,974, filed on Nov. 1, 2023, which is hereby incorporated by reference in its entirety for all purposes.

### BACKGROUND

An increasing number of technology areas are becoming driven by data and the analysis of such data to develop insights. One way to do this is with data science models (e.g., machine-learning models) that may be created based on historical data and then applied to new data to derive insights such as predictions of future outcomes.

In many cases, the use of a given data science model is accompanied by a desire to explain an output of the model, such that an appropriate action might be taken in view of the insight provided. However, many data science models are extremely complex and the manner by which they derive insights can be difficult to analyze. For example, it may not be apparent how the output of a data science model for a particular input data record was influenced by any given feature that the data science model uses as input. Therefore, it can be difficult to interpret which features had the greatest effect on the output generated by the model.

### OVERVIEW

Disclosed herein is a new technique for rapidly, efficiently, and accurately quantifying the influence of specific features (e.g., determining contribution values) on the output of a trained data science model. In one aspect, the disclosed technology may take the form of a method to be carried out by a computing platform that involves (i) receiving a request to compute a score for an input data record, the input data record comprising a group of actual parameters that map to a set of features that a trained data science model is configured to receive as input; (ii) partitioning the set of features into a plurality of global feature groups based on dependencies between the features; (iii) inputting the group of actual parameters into the trained data science model, wherein the trained data science model comprises an ensemble of decision trees, and wherein: (a) each individual decision tree in the ensemble is symmetric, (b) each individual decision tree in the ensemble is configured to receive a respective subset of the features as input, and (c) within each individual decision tree, internal nodes that are positioned in a same level designate a same splitting criterion based on a same feature selected from the respective subset of features; (iv) for each individual decision tree in the ensemble: (a) assigning each individual feature in the subset of features for the individual decision tree to a corresponding local feature group that is a subset of a given global feature group that includes the individual feature, (b) identifying a respective leaf such that the actual parameters satisfy a series of splitting conditions for edges that connect nodes in a respective path from a root of the individual decision tree to the respective leaf, and (c) based on the corresponding local feature groups, determining a set of respective individual contribution values for the respective leaf, wherein each of the respective individual contribution values maps to a respective feature found in the respective subset of features of the individual decision tree; (v) for each individual feature in the set of features, computing a respective overall contribution value based on: (a) the respective global feature group, and (b) a sum of the respective individual contribution values that map to that individual feature; and (vi) compute, via the trained data science model, the score for the input data record.

In some examples, the method carried out by the computing platform further involves: for each individual decision tree in the ensemble, generating a first matrix of weights, wherein each first weight in the first matrix corresponds to a respective subset pair comprising a first subset of the local feature groups and a second subset of the local feature groups.

Further, in some examples, the method carried out by the computing platform involves: for each individual decision tree in the ensemble: generating a second matrix of weights and a third matrix of weights, wherein, for each of a plurality of mixed pairs comprising (i) a respective one of the local feature groups and (ii) a respective subset pair, there is a second corresponding weight in the second matrix and a third corresponding weight in the third matrix.

Still further, in some examples, the method carried out by the computing platform involves: (i) identifying at least one reason code for the score based on the respective overall contribution values for the individual features in the set of features; and (ii) transmitting the score and the at least one reason code in response to the request.

Still further, in some examples, the method carried out by the computing platform involves: prior to receiving the request, training the trained data science model against training data that comprises a plurality of training data records.

Still further, in some examples, determining the set of respective individual contribution values for the respective leaf comprises: (i) identifying each realizable path from the root of the individual decision tree to each realizable leaf in the individual decision tree, respectively; (ii) for each identified realizable path, computing a respective first probability by dividing a number of the training data records that were scored during the training based on the identified realizable path by a total number of training data records in the training data; (iii) for each identified realizable path, identifying a respective score to be assigned to input data records scored by the identified realizable path; (iv) for each level of the individual decision tree, identifying the same feature on which the same splitting criterion specified by the internal nodes at that level is based; (v) identifying subsets of the respective subset of features that the individual decision tree is configured to receive as input; (v) for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree; (vi) for each identified subset of the respective subset of features, computing a sum of the respective first probabilities for each realizable path in the identified subset; and (vii) for each identified subset of the respective subset of features, computing a marginal path expectation by multiplying the respective score for the respective path by the sum for the identified subset.

Still further, in some examples, the method carried out by the computing platform involves: for each individual decision tree in the ensemble: generating, based on the identified groups of realizable paths for the respective path and based on the computed marginal path expectations, a vector of sums of marginal path expectations.

Still further, in some examples, identifying each realizable path from the root of the individual decision tree to each realizable leaf in the individual decision tree, respectively, comprises: (i) identifying a selected path to be evaluated for realizability; (ii) detecting that a first splitting condition for a first edge in the selected path and a second splitting condition for a second edge in the path contradict each other; and (iii) excluding the selected path from a list of realizable paths.

Still further, in some examples, determining the set of respective individual contribution values for the respective leaf comprises: (i) receiving an identifier of a leaf selected from a decision tree in the ensemble; and (ii) based on the identifier of the leaf, determining a set of contribution values to which the identifier maps in a data structure, wherein the determined set of contribution values to which the identifier maps in the data structure is the set of respective individual contribution values.

Still further, in some examples, the method carried out by the computing platform involves: prior to receiving the request, generating a respective set of contribution values for each leaf in the ensemble of decision trees and populate the data structure with entries that map the leaves in the ensemble of decision trees to the respective sets of contribution values, wherein generating a respective set of contribution values comprises: (i) identifying each realizable path from the root of the individual decision tree to each realizable leaf in the individual decision tree, respectively; (ii) for each identified realizable path, computing a respective first probability by dividing a number of the training data records that were scored during the training based on the identified realizable path by a total number of training data records in the training data; (iii) for each identified realizable path, identifying a respective score to be assigned to input data records scored by the identified realizable path; (iv) for each level of the individual decision tree, identifying the same feature on which the same splitting criterion specified by the internal nodes at that level is based; (v) identifying subsets of the respective subset of features that the individual decision tree is configured to receive as input; (vi) for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree; (vii) for each identified subset of the respective subset of features, computing a sum of the respective first probabilities for each realizable path in the identified subset; and (viii) for each identified subset of the respective subset of features, computing a marginal path expectation by multiplying the respective score for the respective path by the sum for the identified subset.

Still further, in some examples, the at least one reason code comprises a model reason code (MRC) or an adverse action reason code (AARC).

In yet another aspect, disclosed herein is a computing platform that includes a network interface for communicating over at least one data network, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In still another aspect, disclosed herein is a non-transitory computer-readable medium provisioned with program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts a simplified block diagram illustrating an example computing environment in which a data science model may be utilized;

FIG. 2 depicts a simplified block diagram illustrating an example data science model that may be executed by a software subsystem of a computing platform according to aspects of the disclosed technology;

FIG. 3A is a flow chart that illustrates one possible example of a precomputation process for determining contribution values for features used in a data science model comprising one or more decision trees in accordance with the present disclosure.

FIG. 3B is a flow chart that illustrates one possible example of a process for calculating contribution values in accordance with the present disclosure;

FIG. 4 is a schematic diagram showing one possible example of grid and a corresponding decision tree with structural characteristics that are unsuitable for use with the processes described in accordance with the present disclosure;

FIG. 5 is a schematic diagram showing one possible example of a grid and a corresponding decision tree with structural characteristics that are suitable for use with the processes described in accordance with the present disclosure;

FIG. 6 is a schematic diagram showing one possible example of an ensemble of decision trees that are suitable for use with the processes described in accordance with the present disclosure;

FIG. 7 is a flow chart that illustrates one possible example of a process for calculating contribution values in accordance with the present disclosure;

FIGS. 8A-F are a series of diagrams that serve to illustrate how example values may be assigned to symbols described herein, according to one simplified example of determining Owen values; and

FIG. 9 is a simplified block diagram that illustrates some structural components of an example computing platform.

### DETAILED DESCRIPTION

Entities in various industries have begun to utilize data science models to derive insights that may enable those entities, and the goods and/or services they provide, to operate more effectively and/or efficiently. The types of insights that may be derived in this regard may take numerous different forms, depending on the entity utilizing the data science model and the type of insight that is desired. As one example, an entity may utilize a data science model to predict the likelihood that an industrial asset will fail within a given time horizon based on operational data for the industrial asset (e.g., sensor data, actuator data, etc.). As another example, data science models may be used in a medical context to predict the likelihood of a disease or other medical condition for an individual, and/or the result of a medical treatment for the individual.

As yet another example, many entities (e.g., companies or corporations) have begun to utilize data science models to help make certain operational decisions with respect to prospective or existing customers of those entities. For instance, as one possibility, an entity may utilize a data science model to help make decisions regarding whether to extend a service provided by that entity to a particular individual. One example may be an entity that provides services such as loans, credit card accounts, bank accounts, or the like, which may utilize a data science model to help make decisions regarding whether to extend one of these services to a particular individual (e.g., by estimating a risk level for the individual and using the estimated risk level as a basis for deciding whether to approve or deny an application submitted by the individual). As another possibility, an entity may utilize a data science model to help make decisions regarding whether to target a particular individual when engaging in marketing of a good and/or service that is provided by the entity (e.g., by estimating a similarity of the individual to other individuals who previously purchased the good and/or service). As yet another possibility, an entity may utilize a data science model to help make decisions regarding what terms to offer a particular individual for a service provided by the entity, such as what interest rate level to offer a particular individual for a new loan or a new credit card account. Many other examples are possible as well.

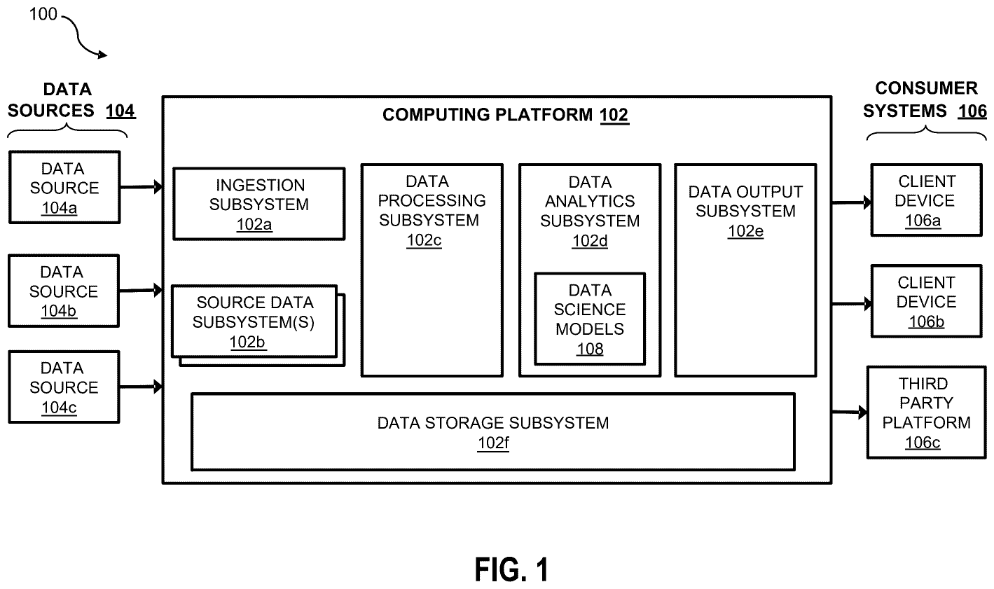

One illustrative example of a computing environment 100 in which an example data science model such as this may be utilized is shown in FIG. 1. As shown, the example computing environment 100 may include a computing platform 102 associated with a given entity, which may comprise various functional subsystems that are each configured to perform certain functions in order to facilitate tasks such as data ingestion, data generation, data processing, data analytics, data storage, and/or data output. These functional subsystems may take various forms.

For instance, as shown in FIG. 1, the example computing platform 102 may comprise an ingestion subsystem 102a that is generally configured to ingest source data from a particular set of data sources 104, such as the three representative data sources 104a, 104b, and 104c shown in FIG. 1, over respective communication paths. These data sources 104 may take any of various forms, which may depend at least in part on the type of entity operating the example computing platform 102.

Further, as shown in FIG. 1, the example computing platform 102 may comprise one or more source data subsystems 102b that are configured to generate and output source data internally for consumption by the example computing platform 102. These source data subsystems 102b may take any of various forms, which may depend at least in part on the type of entity operating the example computing platform 102.

Further yet, as shown in FIG. 1, the example computing platform 102 may comprise a data processing subsystem 102c that is configured to carry out certain types of processing operations on the source data. These processing operations could take any of various forms, including but not limited to data preparation, transformation, and/or integration operations such as validation, cleansing, deduplication, filtering, aggregation, summarization, enrichment, restructuring, reformatting, translation, mapping, etc.

Still further, as shown in FIG. 1, the example computing platform 102 may comprise a data analytics subsystem 102d that is configured to carry out certain types of data analytics operations based on the processed data in order to derive insights, which may depend at least in part on the type of entity operating the example computing platform 102. For instance, in line with the present disclosure, data analytics subsystem 102d may be configured to execute data science models 108 for rendering decisions related to the entity's business, such as a data science model for deciding whether to extend a service being offered by the entity to an individual within a population (e.g., a financial service such as a loan, a credit card account, a bank account, etc.), a data science model for deciding whether to target an individual within a population when engaging in marketing of a good and/or service that is offered by the entity, and/or a data science model for deciding what terms to extend an individual within a population for a service being offered by the entity, among various other possibilities. In practice, each of the data science models 108 may comprise a model object that was trained by applying a machine-learning process to a training dataset, although it should be understood that a data science model could take various other forms as well.

Referring again to FIG. 1, the example computing platform 102 may also comprise a data output subsystem 102e that is configured to output data (e.g., processed data and/or derived insights) to certain consumer systems 106 over respective communication paths. These consumer systems 106 may take any of various forms.

For instance, as one possibility, the data output subsystem 102e may be configured to output certain data to client devices that are running software applications for accessing and interacting with the example computing platform 102, such as the two representative client devices 106a and 106b shown in FIG. 1, each of which may take the form of a desktop computer, a laptop, a netbook, a tablet, a smartphone, or a personal digital assistant (PDA), among other possibilities. These client devices may be associated with any of various different types of users, examples of which may include individuals that work for or with the entity (e.g., employees, contractors, etc.) and/or individuals seeking to obtain goods and/or services from the entity. As another possibility, the data output subsystem 102e may be configured to output certain data to other third-party platforms, such as the representative third-party platform 106c shown in FIG. 1.

In order to facilitate this functionality for outputting data to the consumer systems 106, the data output subsystem 102e may comprise one or more Application Programming Interface (APIs) that can be used to interact with and output certain data to the consumer systems 106 over a data network, and perhaps also an application service subsystem that is configured to drive the software applications running on the client devices 106a-c, among other possibilities.

The data output subsystem 102e may be configured to output data to other types of consumer systems 106 as well.

Referring once more to FIG. 1, the example computing platform 102 may also comprise a data storage subsystem 102f that is configured to store the different data within the example computing platform 102, including but not limited to the source data, the processed data, and the derived insights. In practice, this data storage subsystem 102f may comprise several different data stores that are configured to store different categories of data. For instance, although not shown in FIG. 1, this data storage subsystem 102f may comprise one set of data stores for storing source data and another set of data stores for storing processed data and derived insights. However, the data storage subsystem 102f may be structured in various other manners as well. Further, the data stores within the data storage subsystem 102f could take any of various forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities.

The example computing platform 102 may comprise various other functional subsystems and take various other forms as well.

In practice, the example computing platform 102 may generally comprise some set of physical computing resources (e.g., processors, data storage, communication interfaces, etc.) that are utilized to implement the functional subsystems discussed herein. This set of physical computing resources may take any of various forms. As one possibility, the computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the example computing platform 102 may comprise “on-premises” computing resources of the entity that operates the example computing platform 102 (e.g., entity-owned servers). As yet another possibility, the example computing platform 102 may comprise a combination of cloud computing resources and on-premises computing resources. Other implementations of the example computing platform 102 are possible as well.

Further, in practice, the functional subsystems of the example computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

It should be understood that computing environment 100 is one example of a computing environment in which a data science model may be utilized, and that numerous other examples of computing environments are possible as well.

Most data science models today comprise a trained model object (sometimes called a trained “regressor”) that is configured to (i) receive input data (e.g., actual parameters) for some set of input variables (e.g., formal parameters), (ii) evaluate the input data, and (iii) based on the evaluation, output a “score” (e.g., a likelihood value). For at least some data science models, the score is then used by the data science model to make a classification decision, typically by comparing the score to a specified score threshold (if the score is quantitative as opposed to categorical), depending on the application of the data science model in question.

These types of trained model objects are generally created by training a machine-learning process to a training dataset that is relevant to the particular type of classification decision to be rendered by the data science model (e.g., a set of historical data records that are each labeled with an indicator of a classification decision based on the historical data record, wherein each training instance in the training dataset includes a label for an individual historical data record and the actual parameters specified in that individual historical data record). In this respect, the machine learning process may comprise any of various machine learning techniques, examples of which may include regression techniques, decision-tree techniques, support vector machine (SVM) techniques, Bayesian techniques, ensemble techniques, gradient descent techniques (e.g., including gradient boosting), and/or neural network techniques, among various other possibilities.

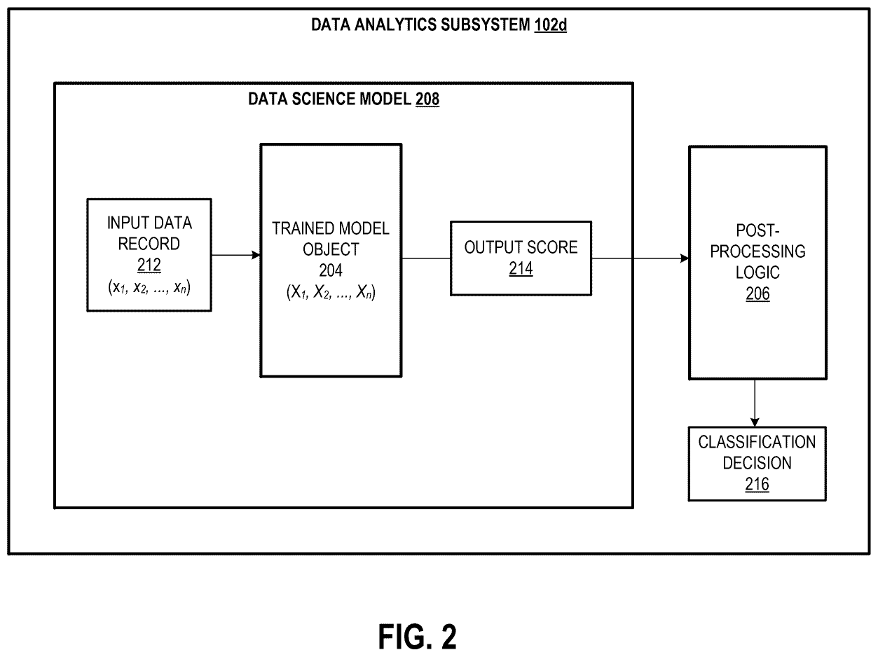

FIG. 2 depicts a conceptual illustration of a data science model 208 for making a classification decision 216 for an input data record 212 in accordance with the present disclosure, which may also be referred to herein as a “classification” model. In the example of FIG. 2, the data science model 208 is shown as being deployed within the example computing platform 102 of FIG. 1 (specifically in the data analytics subsystem 102d of the computing platform 102 of FIG. 1), but it should be understood that the data science model 208 may be deployed within any computing platform that is capable of executing the disclosed data science model 208.

The type of classification decision that is made by the data science model 208 shown in FIG. 2 may take various forms, as noted above. However, for the purposes of FIG. 2 and the examples that follow, the data science model 208 will be referred to as a model for making a decision regarding whether to extend a service (e.g., a loan, a credit card account, a bank account, etc.) being offered by an entity to an individual (e.g., a person or another entity that is capable of being a consumer of the service).

As shown in FIG. 2, the data science model 208 may include a trained model object 204 (e.g., a machine-learning model) that functions to receive the input data record 212 (e.g., an input instance). The input data record 212 includes a set of actual parameters that are represented in FIG. 2 by the set (x₁, x₂, . . . , xₙ). The actual parameters map to a set of formal parameters (e.g., sometimes also referred to as “feature variables,” “features,” or “predictors”) that are used by the trained model object 204 and are represented in FIG. 2 by the set (X₁, X₂, . . . , Xₙ). In this regard, the input data record 212 may include data corresponding to a given individual for whom a classification decision will be made, and may generally comprise data for any variables that may be predictive of whether the given individual is likely to fulfill one or more requirements associated with the service (e.g., variables that provide information related to credit score, credit history, loan history, work history, income, debt, assets, etc.). For example, if the individual is applying for a loan, one requirement associated service may be that the loan be repaid with a certain level of interest after a certain period of time elapses.

In some implementations, the data science model 208 may initially receive source data (e.g., from one or more of the data sources 104 shown in FIG. 1) that may not correspond directly to the input formal parameters specified by the trained model object 204, and/or may include extraneous data that is not used by the trained model object 204, and so on. In these situations, the data science model 208 may first apply pre-processing logic (not shown) to derive, from the source data, the actual parameters that map to the formal parameters that are used by the trained model object 204. In other implementations, the data processing subsystem 102c shown in FIG. 1 may receive the source data from which the actual parameters are derived and may perform the pre-processing logic discussed above (or a portion thereof) before passing the result to the data analytics subsystem 102d and the data science model 208. Other implementations are also possible.

Once the input data record 212 including the actual parameters (x₁, x₂, . . . , xₙ) is received by the trained model object 204 as input, the trained model object 204 may evaluate the input data record 212 based on the actual parameters. Based on the evaluation, the trained model object 204 may determine and output a score 214 that represents a likelihood that the given individual will fulfill one or more requirements associated with the service. For example, the output score 214 may represent a likelihood (e.g., a value between 0 and 1) that the given individual will default on a loan if the loan is extended to the given individual. As further shown in FIG. 2, the data analytics subsystem 102d may then apply post-processing logic 206 to the output score 214 of the data science model 208 in order to render a classification decision 216. For instance, if the output score 214 is above a given threshold, the data analytics subsystem 102d may render a decision not to extend the loan to the individual (e.g., to deny the individual's application for the loan). As another possibility, if the output score 214 is below the given threshold, and additionally below an additional preferred-rate threshold, the data analytics subsystem 102d may render a decision to approve the individual's loan application at a lower interest rate than may be offered to another approved individual for whom the trained model object 204 output a score above the preferred-rate threshold. Various other examples are also possible.

There are various advantages to using a data science model comprising a trained model object (e.g., a machine-learning model) over other forms of data analytics that may be available. As compared to human analysis, data science models can drastically reduce the time it takes to make decisions. In addition, data science models can evaluate much larger datasets (e.g., with far more parameters) while simultaneously expanding the scope and depth of the information that can be practically evaluated when making decisions, which leads to better-informed decisions. Another advantage of data science models over human analysis is the ability of data science models to reach decisions in a more objective, reliable, and repeatable way, which may include avoiding any bias that could otherwise be introduced (whether intentionally or subconsciously) by humans that are involved in the decision-making process, among other possibilities.

Data science models may also provide certain advantages over alternate forms of machine-implemented data analytics like rule-based models (e.g., models based on user-defined rules). For instance, unlike most rule-based models, data science models are created through a data-driven process that involves analyzing and learning from the historical data, and as a result, data science models are capable of deriving certain types of insights from data that are simply not possible with rule-based models—including insights that are based on data-driven predictions of outcomes, behaviors, trends, or the like, as well as other insights that could not be revealed without a deep understanding of complex interrelationships between multiple different data variables. Further, unlike most rule-based models, data science models are capable of being updated and improved over time through a data-driven process that re-evaluates model performance based on newly available data and then adjusts the data science models accordingly. Further yet, data science models may be capable of deriving certain types of insights (e.g., complex insights) in a quicker and/or more efficient manner than other forms of data analytics such as rule-based models. Depending on the nature of the available data and the types of insights that are desired, data science models may provide other advantages over alternate forms of data analytics as well.

When using a data science model comprising a trained model object (e.g., a machine-learning model), it may be desirable to quantify or otherwise evaluate the extent to which different parameters influence or contribute to the model object's output. This type of analysis of the contribution (sometimes also referred to as attribution) of the parameters to a model's output may take various forms.

For instance, it may be desirable in some situations to determine which parameters contribute most heavily to a decision made based on a model object's output on a prediction-by-prediction basis. Additionally, or alternatively, it may be desirable in some situations to determine which parameters contribute most heavily, on average, to the decisions made based on a model object's output over some representative timeframe.

As one example, and referring to the discussion of FIG. 2 above, entities that deny applications for credit (e.g., loan applications) are subject to regulations that oblige those entities to inform the denied individuals as to which factors contributed most to those denials. In this regard, the factors provided to the denied individuals can be referred to as Model Reason Codes (MRCs), sometimes referred to as simply “reason codes.” For example, in the United States, the Equal Opportunity Credit Act (ECOA) mandates that entities that deny applications for credit supply denied individuals with one or more adverse action reason codes (AARCs). Consequently, an entity that utilizes a data science model to make these types of classification decisions should also be prepared to interpret the resulting decisions and identify the corresponding reason codes.

As another example, an entity that manages industrial assets may want to identify the parameters that contributed most to a failure prediction for a given asset. For instance, if a contribution value for a parameter corresponding to particular sensor data or actuator data gathered from the industrial asset is greater than the contribution values of other parameters, a reason for the predicted failure might be readily inferred. This information, in turn, may then help guide the remedial action that may be taken to avoid or fix the problem before the failure occurs in the given asset and/or in other similarly situated assets. If a temperature reading (e.g., an actual parameter that maps to a formal parameter used by the trained model object to represent temperature) from a temperature sensor attached to a polyvinyl chloride (PVC) pipe has a contribution value that greatly exceeds the contribution values of other parameters used by a trained model object, technicians might readily conclude that the predicted failure of the PVC pipe is due to an ambient temperature that approaches or exceeds an upper-bound operating temperature for PVC (e.g., 140 degrees Fahrenheit).

As yet another example, a medical entity that uses data science models to predict the likelihood of disease or other medical conditions for individuals may want to identify the parameters that contributed most to the model's output score for a given individual. This information may then be used to make judgments about the treatments for the individual that may be effective to reduce the likelihood of the disease or medical condition.

Another situation where it may be desirable to analyze the contribution of the parameters used by a model object to the model's output is to determine which parameters contribute most heavily to a bias exhibited by the model object. At a high level, this may generally involve (i) using the model object to score input datasets for two different subpopulations of people (e.g., majority vs. minority subpopulations), (ii) quantifying (e.g., averaging) the contributions of the input variables to the scores for the two different subpopulations, and (iii) using the contribution values for the two different subpopulations to quantify the bias contribution of the variables.

Further details regarding these and other techniques for determining which input variable(s) contribute most heavily to a bias exhibited by a model object can be found in U.S. patent application Ser. No. 17/900,753, which was filed on Aug. 31, 2022, is entitled “COMPUTING SYSTEM AND METHOD FOR CREATING A DATA SCIENCE MODEL HAVING REDUCED BIAS,” and is incorporated herein by reference in its entirety.

Note that this type of analysis may not be trivial. Depending on the complexity or structure of the model object, the contribution or influence of a formal parameter might not be constant across different values of actual parameters that map to that same formal parameter. For example, suppose that a first input data record includes “30,000” as an actual parameter that maps to a formal parameter representing annual salary and “815” as an actual parameter that maps to a formal parameter representing credit rating. Also suppose that a second input data record includes “200,000” as an actual parameter that maps to the formal parameter representing annual salary and “430” as an actual parameter that maps to the formal parameter representing credit rating. Also suppose that the model object outputs scores for both the first input data record and the second input data record that do not satisfy a threshold condition for loan approval. The score for the first input data record may have been influenced primarily by the annual salary parameter, while the score for the second input data record may have been influenced primarily by the credit rating parameter. Thus, the influence of a particular formal parameter on a score may vary based both on the corresponding actual parameter and on the actual parameters that correspond to other formal parameters. As the number of formal parameters the model object uses increases, the complexity of determining the contributions of individual parameters may increase exponentially.

Several techniques have been developed for quantifying the contribution of a trained model object's parameters. These techniques, which are sometimes referred to as “interpretability” techniques or “explainer” techniques, may take various forms. As one example, a surrogate linear function in a simplified space is used in Local Interpretable Model-agnostic Explanations (LIME), and the linear function is used for explaining the output. Another example technique is Partial Dependence Plots (PDP), which utilizes the model object directly to generate plots that show the impact of a subset of the parameters in the overall input data record (also referred to as the “predictor vector”) on the output of the model object. PDP is similar to another technique known as Individual Conditional Expectation (ICE) plots, except an ICE plot is generated by varying the value of a single actual parameter in a specific input data record while holding the values of other actual parameters constant, whereas a PDP plot is generated by varying a subset of the parameters after the complementary set of parameters has been averaged out. Another technique known as Accumulated Local Effects (ALE) takes PDP a step further and partitions the predictor vector space and then averages the changes of the predictions in each region rather than the individual parameters.

Yet another explainer technique is based on the game-theoretic concept of the Shapley value described in Shapley, “A Value for n-Person Games,” in Kuhn and Tucker, CONTRIBUTIONS TO THE THEORY OF GAMES II, Princeton University Press, Princeton, 307-317 (1953), available at https://doi.org/10.1515/9781400881970-018, which is incorporated by reference herein in its entirety. Given a cooperative game with n players, a set function v that acts on a set N:={1, 2, . . . n} and satisfies v(Ø)=0, the Shapley values assign contributions to each player i∈N to the total payoff v(N), and is given by

$${ϕ}_{i} [ v ] = {\sum }_{S ⊆ N \backslash \{ i \}} \frac{s ! ( n - s - 1 ) !}{n !} ( v ( S ⋃ \{ i \} ) - v ( S ) ) , s := \vert S \vert , n := \vert N \vert$$

by considering the possible combinations of a player i and the rest of the players.

In the machine learning setting, the features (e.g., formal parameters) X=(X₁, X₂, . . . . Xₙ) are viewed as n players with an appropriately designed game v (S; x, X, f) where x is an observation (e.g., an actual parameter; a predictor sample from the training dataset of features D_{X}), X is a random vector of features, and f corresponds to the model object and S⊆N. The choice of the game is crucial for a game-theoretic explainer (see Miroshnikov et al. 2024), which is cited below); it determines the meaning of the attribution (explanation) value. Two notable games in the ML literature are the conditional and marginal games given by

$${v}^{C E} ( S ; x , X , f ) = [ f ( X ) \vert {X}_{S} = {x}_{S} ] and$$

$${v}^{M E} ( S ; x , X , f ) = [ f ( {x}_{S} , {X}_{- S} ) ]$$

introduced in Lundberg and Lee (2017). Shapley values of the conditional game—i.e., conditional Shapley values—explain predictions ƒ(X) viewed as a random variable, while Shapley values for the marginal game—i.e., marginal Shapley values-explain the (mechanistic) transformations occurring in the model ƒ(x).

In practice, conditional or marginal games are typically replaced with their empirical analogs that utilize data samples. Computing conditional game values is generally infeasible when the predictor dimension (i.e., the number of formal parameters) is large; this might be considered the curse of dimensionality. The marginal game, however, is often approximated with the empirical marginal game \hat{v}^{ME}(S; x, D̅_{X}, f) given by

$${\hat{v}}^{M E} ( S ; x , {\overline{D}}_{X} , f ) := \frac{1}{\vert {\overline{D}}_{X} \vert} {\sum }_{\tilde{x} ∈ {\overline{D}}_{X}} f ( {x}_{S} , {\tilde{x}}_{- S} )$$

where D̅_{X} is a background dataset of a vector of features, a subset of the dataset D_{X} containing a vector of features X used for training (e.g., the input data record 212 shown in FIG. 2, including actual parameters x₁, x₂, . . . xₙ stored in D_{X} that are samples corresponding to the formal parameters X₁, X₂, . . . Xₙ).

The marginal Shapley value ϕᵢ[v^{ME}] of the feature indexed by the subscript i at x, that is the Shapley value for the game v^{ME} (S; x, X, f), takes into account the set of possible combinations between a feature of interest (e.g., the parameter whose contribution is to be determined) and the rest of the features in the input vector and produces a score (e.g., a scalar value) that represents the contribution of that feature to the deviation of the model prediction for the specific instance of the input vector (e.g., the actual parameters x₁, x₂, . . . xₙ) from the model's average prediction. The empirical marginal Shapley value ϕᵢ[\hat{v}^{ME}] is the statistical approximant of ϕᵢ[v^{ME}], which has complexity of the order O(2ⁿ·D̅_{X}|) and represents the number of terms in the Shapley formula times the number of evaluations over the size (e.g., cardinality, as indicated by the operator |·|) of the dataset D̅_{X}.

In the remaining parts of the document, the term “Shapley values” (or “marginal Shapley values”), refers to the Shapley values ϕᵢ[v^{ME}], i=1, 2, . . . n, of the marginal game, The Shapley values are denoted by ϕᵢ^{ME} or ϕᵢ^{ME}(x) where the information on the model f and the random variable X is suppressed.

Marginal Shapley values, as discussed herein, generate individual contributions of predictor values. It will be appreciated that the marginal Shapley value often cannot be computed because it presupposes knowledge of the distribution of X. While the evaluation of the empirical marginal game \hat{v}^{ME}(S; x, D̅_{X}, f) is relatively tractable (if the background dataset is small), to evaluate the empirical marginal Shapley value itself is expensive to compute because the Shapley value formula contains the summation over the possible subsets S⊆N, leading to 2ⁿ terms. The complexity can quickly result in intractability if the number of features n is large. If the background dataset is large (e.g., it is chosen to be the training dataset), then evaluating the empirical marginal game alone also becomes computationally expensive.

One practical implementation of using Shapley values to quantify variable contributions is an algorithm referred to as KernelSHAP, described in Lundberg et al., “S. M. Lundberg and S.-I. Lee, A unified approach to interpreting model predictions”, 31st Conference on Neural Information Processing Systems, (2017), which is incorporated by reference herein in its entirety. KernelSHAP is utilized to compute the marginal Shapley value for each input variable. The KernelSHAP method approximates Shapley values for the marginal game (in view of the assumption of feature independence made by the authors) via a weighted least square problem and it is still very expensive computationally when the number of predictors is large.

Another algorithm, called TreeSHAP, described in Lundberg et al., “Consistent individualized feature attribution for tree ensembles,” ArXiv, arxiv:1802.03888 (2019), which is incorporated by reference herein in its entirety, is utilized to compute the Shapley value of a specially designed tree-based game which mimics the conditioning of the model by utilizing the tree-based model structure. The (path-dependent) TreeSHAP algorithm is a fast method in which the training data does not have to be retained to determine contribution values, but in general it produces neither marginal nor conditional Shapley values (nor their approximants) when dependencies between predictors exist. Furthermore, the contribution values it produces can vary based on implementation details. In terms of complexity, the path-dependent algorithm runs in O(T·L·log(L)²) time, where T is the number of trees comprising the model and L is the upper-bound number of leaves. For one to obtain marginal Shapley values, an adaptation of the TreeSHAP algorithm was proposed called Interventional TreeSHAP, described in Lundberg et al., “From local explanations to global understanding with explainable Al for trees”, Nature Machine Intelligence 2, 56-67 (2020), which is incorporated herein by reference in its entirety. It is not as fast as the path-dependent version of the algorithm because it averages over a background dataset D̅_{X} to compute the empirical marginal expectations. However, the complexity is linear in the number of samples (e.g., training instances), and specifically Interventional TreeSHAP has complexity O(T·D̅_{X}|·L), where again T is the number of trees and L is the upper-bound number of leaves. Note that the values produced by TreeSHAP are model-specific and, in the case of the path-dependent algorithm, they depend on the make-up of the tree-model ƒ(x) in terms of trees: for two different make-ups of some tree-based model ƒ(x), the attribution values will generally differ; this is generally not desirable for an application such as the production of reason codes.

KernelSHAP (which is model agnostic) is relatively slow due to computational complexity, so it is limited in its application when the number of features is large. Furthermore, KernelSHAP assumes independence between features. On the other hand, TreeSHAP is limited because its path-dependent version produces attributions (e.g., contribution values) that may not be conditional Shapley values and its interventional version requires a background dataset to be used.

In general, a marginal Shapley value may represent, for a given input data record x that was scored by a trained model object ƒ(x), a value (e.g., an “explanation” value or a contribution value) for each parameter that indicates the parameter's contribution to the model's output score for the given input data record. For example, if a trained model object's output is a regressor score (i.e., a probability value with value between 0 and 1) a marginal Shapley value may be expressed as a number between −1 and 1, with a positive value indicating a positive contribution to the output and a negative value indicating a negative contribution to the output. Further, the magnitude of the marginal Shapley value may indicate the relative strength of its contribution.

In this regard, it will be understood that a marginal Shapley value for a given parameter should be interpreted in view of how the data science model defines its output. Returning to the example discussed in FIG. 2 above, the trained model object 204 may be trained to output a score that indicates a likelihood that an individual will fulfill one or more requirements associated with the service, where a higher score indicates that the individual is less likely to fulfill the one or more requirements. Accordingly, a positive Shapley value for any of the parameters X₁, X₂, . . . X, in FIG. 2 would indicate that the parameter contributed to pushing the score higher. On the other hand, a negative Shapley value for any of the parameters X₁, X₂, . . . Xₙ would indicate that the parameter contributed to pushing the risk score lower.

One of the drawbacks of the explainer techniques discussed above is that they fail to account for dependencies between input variables (this is relevant to both KernelSHAP and TreeSHAP). KernelSHAP generally treats input variables as independent from each other (which is often not the case in practice). TreeSHAP relies on the structure of the regression trees that make up the model and its path-dependent version only partially respects dependencies.

To address these and other shortcomings with the techniques discussed above, disclosed herein is a new approach that facilitates rapid computation and retrieval of contribution values for features used by model objects that satisfy several strategic constraints. Specifically, this approach exploits advantages that can be gained by creating an ensemble of decision trees whose structures satisfy specific structural constraints that are described herein.

When the decision trees in the ensemble satisfy these structural constraints (e.g., the decision trees are oblivious), the formula to determine marginal Shapley values for features used by a decision tree can be simplified to obtain a formula of lower computational complexity. When this simplified formula is leveraged in the context of a computing system, the computational efficiency of that system is increased such that the amount of computing resources (e.g., processor cores or memory) used to accomplish a task in a target amount of time can be greatly reduced. For example, suppose an ensemble of decision trees is used to classify a given input data record.

Further suppose Shapley values are desired for features on which decision trees in the ensemble split so that the reasons why the ensemble assigned a particular output class to the input data record features will be more apparent. If no precomputations (which will be described in greater detail below) have been performed beforehand, methods described herein can be used to compute the Shapley values for the features with a computational complexity of log(L)·L^{1.6} (for a fixed observation), where L denotes the number of leaves in the ensemble of decision trees included in a data science model. While the computational complexity of L^{1.6} constitutes an advantage over the techniques mentioned above for computing Shapley values, even greater advantages can be gained by performing precomputations as described below.

Regarding these precomputations, as will be explained in the examples below, the set of contribution values (e.g., marginal Shapley values, Owen values, etc.) for the features used by a decision tree that satisfies the aforementioned structural constraints is constant across input data records that land in the same leaf. As a result, leaves can be mapped to sets of contribution values (rather than individual input data records alone to contribution values on a case-by-case basis) such that the set of Shapley values for an input data record can be inferred directly from the leaf in which the input data record falls. Since leaves can be mapped to contribution values, the set of contribution values to which a leaf maps can be determined via precomputation beforehand and stored in a data structure (e.g., a lookup table) that maps leaves to sets of contribution values for the features on which a decision tree splits. The method of computational complexity L^{1.6} mentioned above can therefore be used to determine the contribution values to which each leaf in each decision tree in an ensemble maps before any input records are classified. The complexity of precomputing the contribution values across each leaf in the ensemble is the number of leaves L multiplied by the complexity L^{1.6} of determining the contribution values for a single leaf. Therefore, the complexity of precomputing the contribution values across each leaf in the ensemble is L*L^{1.6}=L^{2.6}. In practice, for a single tree, the precomputation of the contribution values for the leaves in the tree can be completed in less than one second. Collectively, for multiple trees included in an ensemble, if the depth of the trees in the ensemble does not exceed fifteen, the number of trees in the ensemble does not exceed one thousand, and sufficient processors and memory are engaged, the collective precomputation of the contribution values for the leaves in the ensemble can be completed in a matter of minutes. If the depth of the trees is less than fifteen (e.g., nine) and the number of trees in the ensemble is less than one thousand (e.g., six hundred fifty), the collective precomputation of the contribution values for the leaves in the ensemble can be completed in a few minutes (e.g., 182 seconds without threading or 45 seconds with thirty-two threads).

Once the precomputation has been completed and the results have been stored in a data structure such as a lookup table, the set of contribution values for the features which an ensemble uses to classify an input data record can be determined with logarithmic complexity rather than exponential complexity. This is because the complexity of identifying the leaves of the trees in the ensemble into which the input data record lands is an operation of logarithmic complexity. Specifically, for each respective decision tree in the ensemble, identifying the leaf into which the input data record lands amounts to traversing a path through the respective decision tree from the root to a leaf. The respective decision tree is binary, so finding the leaf into which the input data record lands for the respective tree is O(Log(L)) (where L is the number of leaves in the respective tree). There are T decision trees in the ensemble and the input data record will land in a respective leaf in each of those trees, so identifying the leaves in the ensemble into which the input data record falls is O(T·Log(L)). Once the leaves in which the input data record lands are known, the contribution values to which those leaves map can be retrieved from the data structure (lookup table) via an O(1) lookup operation for each tree in the ensemble. Given the additive property of certain types of contribution values (e.g., marginal Shapley values), the contribution values for the ensemble as a whole can be readily computed by summing the contribution values for the individual decision trees. In practice, this results in a system that greatly reduces the latency involved in determining contribution values. Specifically, the time of computation for the contribution values for the ensemble as a whole (e.g., for an instance defined by an input data record that represents an individual) is about 0.0001 seconds. Thus, sets of contribution values for ten thousand individuals can be determined in one second.

Furthermore, the data needed to perform the methods described herein is contained in the decision trees themselves. As a result, the contribution values can be computed without access to the training dataset that was used to train the ensemble. This provides another advantage over existing approaches (e.g., Interventional TreeSHAP) that involve accessing training data to calculate game values because memory usage is greatly reduced in cases where the training dataset is large (a common occurrence in many industries, since larger training datasets tend to yield better machine-learning models). The processes and systems described herein can therefore be deployed in computing environments that might lack sufficient memory to store a complete training dataset. The processes and systems described herein thus empower such computing environments to perform tasks that those computing environments would not be able to perform if previous approaches were to be used.

The Categorical Boosting (CatBoost) algorithm (which is familiar to those of ordinary skill in the art) uses gradient boosting to produce an ensemble of decision trees that meet the constraints discussed above. CatBoost can be used without modification in conjunction with the processes disclosed herein. The ensembles produced by CatBoost achieve levels of prediction accuracy comparable to those of other types of machine-learning models (e.g., neural networks) that, although capable of achieving high levels of prediction accuracy, do not lend themselves to having those predictions explained in terms of how much each feature influenced any particular prediction. In addition, the running time for CatBoost is generally less than the running time for other machine-learning algorithms (e.g., XGBoost) that can achieve comparable levels of prediction accuracy. There are some types of machine-learning models (e.g., explainable boosting machines and explainable neural networks) that do lend themselves to having their predictions explained, but those models typically fail to achieve the levels of prediction accuracy of their non-explainable counterparts. When implemented as part of the systems and processes described herein, CatBoost can offer the best of both worlds by achieving high prediction accuracy while also providing the option to obtain explanations for individual predictions via the simplified formula and the other techniques described herein.

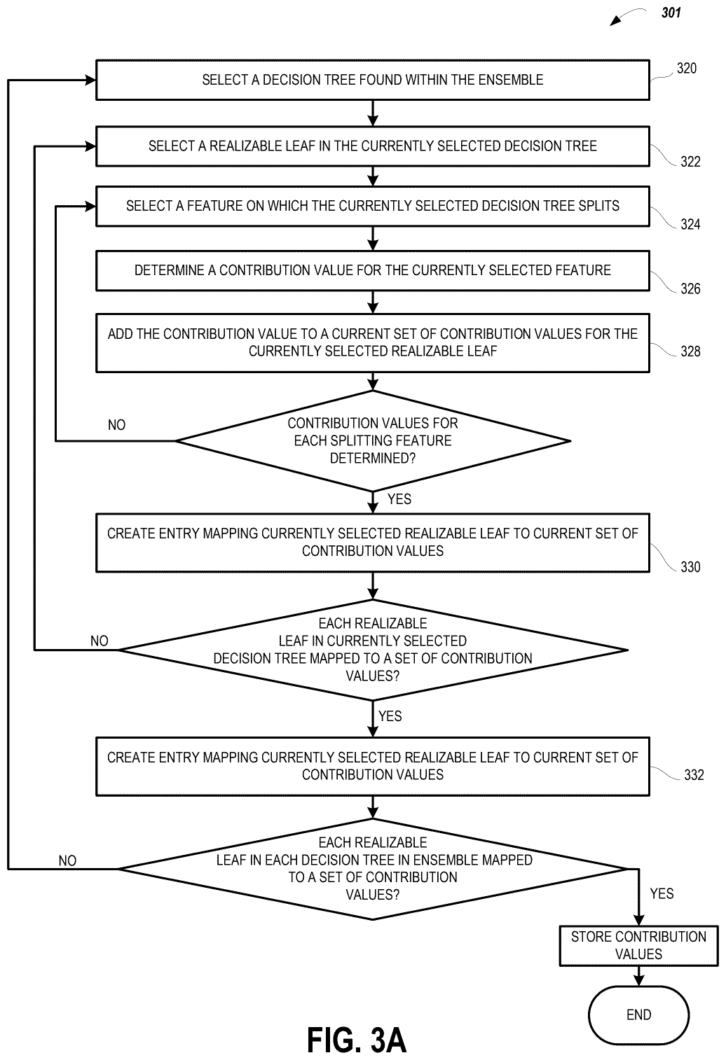

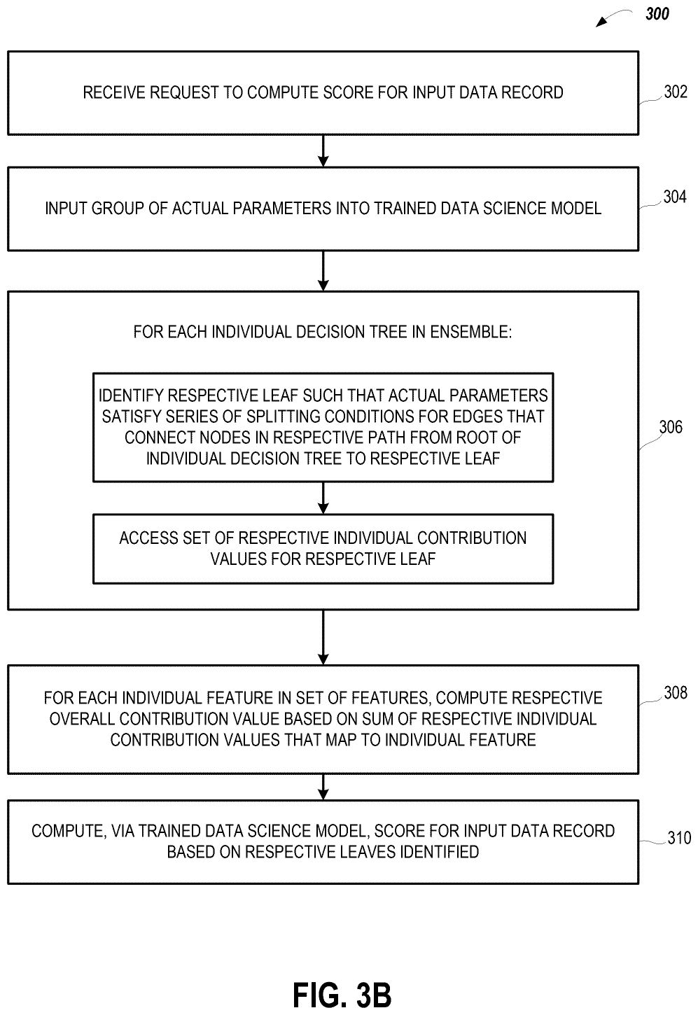

Turning to FIG. 3A, a flow chart is shown that illustrates one example of a precomputation process for determining contribution values for features used in a data science model comprising one or more decision trees in accordance with the present disclosure. The example process 301 may be carried out by any computing platform that is capable of creating a data science model, including but not limited to the computing platform 102 of FIG. 1. Further, it should be understood that the example process 300 of FIG. 3 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

Prior to commencement of the example process 301, a model object for a data science model that is to be deployed by an entity for use in making a particular type of decision may be trained. In general, this model object may comprise any model object that is configured to (i) receive an input data record comprising a set of actual parameters that are related to a respective individual (e.g., person) and map to a particular set of formal parameters (which may also be referred to as the model object's “features” or the model object's “predictors”), (ii) evaluate the received input data record, and (iii) based on the evaluation, output a score that is then used make the given type of decision with respect to the respective individual. Further, the model object that is trained may take any of various forms, which may depend on the particular data science model that is to be deployed.

For instance, as one possibility, the model object may comprise a model object for a data science model to be utilized by an entity to decide whether or not to extend a particular type of service (e.g., a loan, a credit card account, a bank account, or the like) to a respective individual within a population. In this respect, the set of formal parameters for the model object may comprise data variables that are predictive of whether or not the entity should extend the particular type of service to a respective individual (e.g., variables that provide information related to credit score, credit history, loan history, work history, income, debt, assets, etc.), and the score may indicate a likelihood that the entity should extend the particular type of service to the respective individual, which may then be compared to a threshold value in order to reach a decision of whether or not to extend the particular type of service to the respective individual.

The function of training the model object may also take any of various forms, and in at least some implementations, may involve applying a machine-learning process to a training dataset that is relevant to the particular type of decision to be rendered by the data science model (e.g., a set of historical data records for individuals that are each labeled with an indicator of whether or not a favorable decision should be rendered based on the historical data record). In this respect, the machine-learning process may comprise any of various machine learning techniques, examples of which may include regression techniques, decision-tree techniques, support vector machine (SVM) techniques, Bayesian techniques, ensemble techniques, gradient descent techniques, and/or neural-network techniques, among various other possibilities.

As shown in FIG. 3A, the example process 301 may begin at block 320 by selecting a decision tree found within an ensemble of decision trees included in the data science model.

As shown in block 322, the example process 301 further includes selecting a realizable leaf in the currently selected decision tree.

As shown in block 324, the example process 301 further includes selecting a feature on which the currently selected decision tree splits.

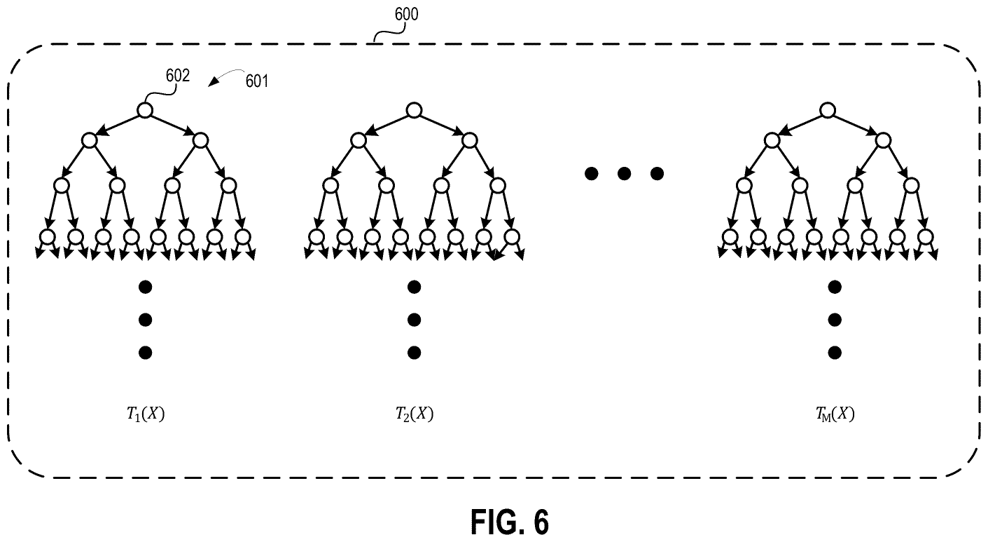

As shown in block 326, the example process 301 further includes determining a contribution value for the currently selected feature. The contribution value may be determined, for example, using the approach described below with respect to FIG. 6.

As shown in block 328, the example process 301 may further include adding the contribution value to a current set of contribution values for the currently selected realizable leaf. If contribution values for each feature on which the currently selected decision tree splits have been determined, the flow of the example process 301 moves to block 330. Otherwise, the flow of the example process 301 moves back to block 324 for the next feature on which the currently selected decision tree splits to be selected.

As shown in block 330, if contribution values for each feature on which the currently selected decision tree splits have been determined, an entry that maps the currently selected realizable leaf to the current set of contribution values is created. If there are entries in data structure that map each realizable leaf in the currently selected decision tree to a respective set of contribution values, the flow of the example process 301 moves to block 332. Otherwise, the flow of the example process 301 moves to block 322 for the next realizable leaf to be selected.

As shown in block 332, if the realizable leaves in each decision tree in the ensemble have been mapped to contribution values, the example process 301 terminates after storing the contribution values (e.g., in a computer-readable storage medium for future retrieval). Otherwise, the flow of the example process 301 moves back to block 320 so that the next decision tree in the ensemble can be selected. In this manner, the data structure that maps realizable leaves in the ensemble to sets of contribution values can be populated.

Turning to FIG. 3B, a flow chart is shown that illustrates one example of a process 300 for determining contribution values for features used in a data science model comprising one or more decision trees in accordance with the present disclosure. The example process 300 of FIG. 3B may be carried out by any computing platform that is capable of creating a data science model, including but not limited to the computing platform 102 of FIG. 1. Further, it should be understood that the example process 300 of FIG. 3B is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

Prior to commencement of the example process 300, a model object for a data science model that is to be deployed by an entity for use in making a particular type of decision may be trained. In general, this model object may comprise any model object that is configured to (i) receive an input data record comprising a set of actual parameters that are related to a respective individual (e.g., person) and map to a particular set of formal parameters (which may also be referred to as the model object's “features” or the model object's “predictors”), (ii) evaluate the received input data record, and (iii) based on the evaluation, output a score that is then used make the given type of decision with respect to the respective individual. Further, the model object that is trained may take any of various forms, which may depend on the particular data science model that is to be deployed.

For instance, as one possibility, the model object may comprise a model object for a data science model to be utilized by an entity to decide whether or not to extend a particular type of service (e.g., a loan, a credit card account, a bank account, or the like) to a respective individual within a population. In this respect, the set of formal parameters for the model object may comprise data variables that are predictive of whether or not the entity should extend the particular type of service to a respective individual (e.g., variables that provide information related to credit score, credit history, loan history, work history, income, debt, assets, etc.), and the score may indicate a likelihood that the entity should extend the particular type of service to the respective individual, which may then be compared to a threshold value in order to reach a decision of whether or not to extend the particular type of service to the respective individual.

The function of training the model object may also take any of various forms, and in at least some implementations, may involve applying a machine-learning process to a training dataset that is relevant to the particular type of decision to be rendered by the data science model (e.g., a set of historical data records for individuals that are each labeled with an indicator of whether or not a favorable decision should be rendered based on the historical data record). In this respect, the machine-learning process may comprise any of various machine learning techniques, examples of which may include regression techniques, decision-tree techniques, support vector machine (SVM) techniques, Bayesian techniques, ensemble techniques, gradient descent techniques, and/or neural-network techniques, among various other possibilities.

As shown in FIG. 3B, the example process 300 may begin at block 302 upon receiving a request to compute a score for an input data record. The input data record may comprise a group of actual parameters that map to a set of features that a trained data science model (e.g., the model object) is configured to receive as input.

As shown in block 304, the example process 300 further includes inputting the group of actual parameters into the trained data science model. The trained data science model comprises an ensemble of decision trees wherein each individual decision tree in the ensemble is symmetric, each individual decision tree in the ensemble is configured to receive a respective subset of the features as input, and, within each individual decision tree, internal nodes that are positioned in a same level designate a same splitting criterion based on a same feature selected from the respective subset of features. The trained data science model may be, for example, a categorical boosting (CatBoost) model.

As shown in block 306, the example process 300 further includes, for each individual decision tree in the ensemble, identifying a respective leaf such that the actual parameters satisfy a series of splitting conditions for edges that connect nodes in a respective path from a root of the individual decision tree to the respective leaf, and accessing a set of respective individual contribution values (e.g., via retrieval from a storage location in a computer-readable medium) for the respective leaf. (In this example, the set of respective individual contribution values was precomputed and stored beforehand via a process such as the example process 301 shown in FIG. 3A.) Each of the respective individual contribution values maps to a respective feature found in the respective subset of features. The respective individual contribution values and the respective overall contribution values may be, for example, Shapley values, Owen values, or Banzhaf-Owen values.

In one example, determining the set of respective individual contribution values for the respective leaf comprises a number of actions, such as: identifying each realizable path from the root of the individual decision tree to each realizable leaf in the individual decision tree, respectively; for each identified realizable path, computing a respective first probability by dividing a number of the training data records that were scored during the training based on the identified realizable path by a total number of training data records in the training data; for each identified realizable path, identifying a respective score to be assigned to input data records scored by the identified realizable path; for each level of the individual decision tree, identifying the same feature on which the same splitting criterion specified by the internal nodes at that level is based; identifying subsets of the respective subset of features that the individual decision tree is configured to receive as input; for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree; for each identified subset of the respective subset of features, computing a sum of the respective first probabilities for each realizable path in the identified subset; and for each identified subset of the respective subset of features, computing a marginal path expectation by multiplying the respective score for the respective path by the sum for the identified subset. This same set of actions can be applied to each leaf in the ensemble. The sets of contribution values generated thereby may be used to populate a data structure with entries that map the leaves in the ensemble of decision trees to the respective sets of contribution values.

The action of identifying each realizable path from the root of the individual decision tree to each realizable leaf in the individual decision tree, respectively, may involve identifying a selected path to be evaluated for realizability; detecting that a first splitting condition for a first edge in the selected path and a second splitting condition for a second edge in the path contradict each other; and excluding the selected path from a list of realizable paths.

In some examples, the set of respective individual contribution values for the respective leaf may have been computed beforehand and stored in a data structure that maps leaves to respective sets of contribution values. In such examples, determining the set of respective individual contribution values for the respective leaf may involve: receiving an identifier of a leaf selected from a decision tree in the ensemble; and, based on the identifier of the leaf, determining a set of contribution values to which the identifier maps in the data structure. (The determined set of contribution values to which the identifier maps in the data structure is the set of respective individual contribution values.)

As shown in block 308, the example process 300 further includes, for each individual feature in the set of features, computing a respective overall contribution value based on a sum of the respective individual contribution values that map to that individual feature. This may be achieved, for example, by summing the local contribution values for each tree in the ensemble for the individual feature.

As shown in block 310, the example process 300 further includes computing, via the trained data science model, the score for the input data record based on the respective leaves identified.

The example process may further include identifying at least one reason code for the score based on the respective overall contribution values for the individual features in the set of features. Still further, the example process 300 may include transmitting the score and the at least one reason code in response to the request.

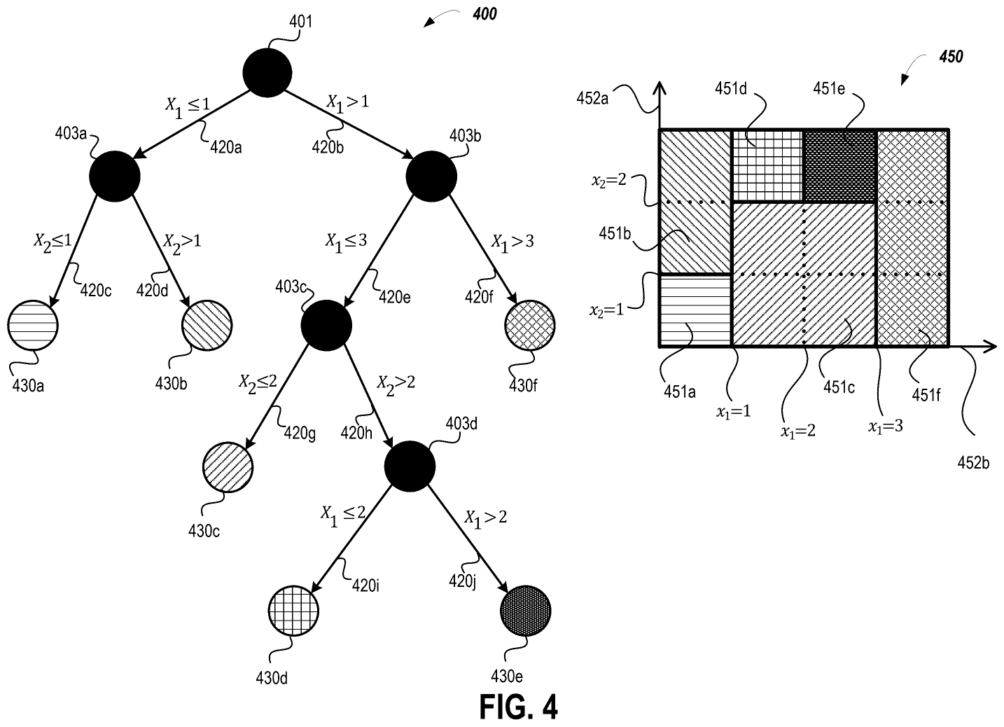

Turning to FIG. 4, a decision tree 400 is shown that will be referred to in the following examples. FIG. 4 also depicts a grid 450 that illustrates regions that map to the leaves 430a-f of the decision tree 400, according to one example. The inequalities that are shown adjacent to the edges 420a-j of the decision tree 400 represent splitting conditions that will determine the path from the root 401 of the decision tree 400 to one of the leaves 430a-f of the decision tree 400 based on a group of actual parameters included in a given input data record.

As will be recognized by persons of ordinary skill in the art, formal parameters refer to variables that act as placeholders within the definition of a function, a subroutine, a procedure (e.g., in procedural programming languages), or any module of code that (i) has its own local variable scope and (ii) can receive, through a parameter list supplied when the module (e.g., function) is called, values (e.g., actual parameters, which are sometimes called “arguments”) to be used in place of the placeholder variables (e.g., formal parameters) declared in the module definition during execution of the module with the supplied parameter list.

A decision tree is one example of a function in that a decision tree (1) receives values, (2) compares those values to a series of splitting conditions for edges (e.g., arcs or directed edges) that connect nodes in the tree to identify a path from the root node of the tree to a leaf of the tree such that those values satisfy the splitting conditions for edges that connect nodes in a path from the root to a leaf, and (3) returns a label (e.g., a score) associated with the leaf.

As will be recognized by persons of ordinary skill in the art, a decision tree can be represented by a connected acyclic graph in which each node (i.e., vertex) other than the root is the head or target (i.e., terminal vertex) of a single directed edge and each internal node (i.e., a node that is not a leaf node) is the tail (i.e., initial vertex) of at least one directed edge. (In the case of a binary tree, each internal node is the initial vertex of at least one directed edge and no more than two directed edges.) Each directed edge connects a node from an n^{th} level of the tree to a node in the (n+1)^{th} level in the tree, where n is a non-negative integer. (For reference, in accordance with nomenclature conventions known to those of skill in the art, the root of a decision tree is considered to be positioned in the first level of that decision tree.) The root of a decision tree is a source (i.e., a node with an in-degree of zero); each leaf in a decision tree is a sink (i.e., a node with an out-degree of zero).

With regard to nomenclature for binary trees that will be familiar to those of skill in the art, the decision tree 400 is a “full” binary tree because each node in the decision tree 400 is an initial vertex of zero or two edges. As will be recognized by those of skill in the art, the “depth” of a given node is the number of edges in the path from the root node to the given node (thus, the depth of a root node is zero). The height of a binary tree is the depth of the leaf in the binary node that is farthest from the root node. The decision tree 400 is not “balanced” because the height of the left subtree of the root 401 differs from the height of the right subtree of the root 401 by more than one level. Furthermore, the decision tree 400 is not “complete” because some levels of the decision tree 400 other than the last level (which is the fifth level in this example) are not filled. Also, the decision tree 400 is not a “perfect” binary tree. A “perfect” binary tree is a special type of binary tree in which each leaf is at the same level (i.e., depth), and each internal node has two children. However, as shown in FIG. 4, some of the leaves 430a-f are positioned in different levels (although each of the internal nodes 403a-d is an initial vertex of two directed edges).

For the purposes of FIG. 4, the group of actual parameters will be denoted as (x₁, x₂). The formal parameters (e.g., features) that the decision tree 400 is configured to receive as input will be denoted by (X₁, X₂). Each of the actual parameters (x₁, x₂) maps, respectively, to the formal parameter that has a matching subscript. This is consistent with convention in many programming languages (i.e., actual parameters provided in an ordered list during a function call are presumed to map to the formal parameters that are in the same positions, respectively, in the ordered list of parameters in the function definition). Thus, in this example, x₁ maps to X₁. Similarly, x₂ maps to X₂. While the decision tree 400 is configured to receive two parameters as input for the sake of simplicity in this example, persons of skill in the art will recognize that decision trees may be configured to receive more than two parameters as input (e.g., dozens of parameters).

Since the decision tree 400 is configured to receive two formal parameters as input, the decision tree 400 is a function of two variables. The domain (i.e., the set of possible input values for which the function is defined) of the decision tree 400 can, therefore, be represented intuitively in two dimensions by the grid 450. The range (i.e., set of possible output values that the function can output) of the decision tree 400 is indicated by the regions 451a-f into which the grid 450 is divided.

The vertical axis 452a depicts a set of potential values ranging from zero to three that the actual parameter x₂ may specify for the formal parameter X₂. Similarly, the horizontal axis 452b depicts a set of potential values from zero to four that the actual parameter x₁ may specify for the formal parameter X₁. Note, however, that these sets of potential values have not been selected for this example to imply that any upper bounds or lower bounds exist on the possible values that may be specified for the formal parameters (X₁, X₂); the output for the decision tree 400 is still defined for (i) values of x₁ that are less than zero or greater than four and for (ii) values of x₂ that are less than zero or greater than three. Rather, these sets of potential values have been selected for illustrative purposes so that the portion of the domain of the decision tree 400 depicted by the grid 450 is large enough to include a region of the tree that maps to each of the leaves 430a-f, respectively. Each of the regions 451a-f maps to a respective one of the leaves 430a-f (as indicated by the respectively matching fill patterns of 451a-f and 430a-f) for reasons that will be explained in greater detail below,

Consider, for example, the region 451a. The region 451a represents cases in which x₁ is a value between zero and one, inclusive, and x₂ is also a value between zero and one, inclusive. If the decision tree 400 is evaluated against a set of actual parameters (x₁, x₂) that satisfy these constraints, the decision tree 400 will return the score that is associated with the leaf 430a. This can be verified in this example by beginning at the root 401 of the decision tree 400 and comparing the actual parameters (x₁, x₂) to the splitting criterion for the root 401. The splitting criterion for the root 401 is expressed by the splitting conditions for the edges 420a-b because these are the two edges for which the root 401 is the initial vertex. In this example, the splitting criterion for the root 401 designates a threshold (the number one, in this case).

As shown, the splitting conditions for the edges 420a-b are mutually antithetical. In other words. if the splitting condition for the edge 420a (i.e., X₁≤1) is satisfied, the splitting condition for the edge 420b (i.e., X₁>1) is not satisfied. Conversely, if the splitting condition for the edge 420b is satisfied, the splitting condition for the edge 420a is not satisfied. Stated more generally, in this example, the splitting condition for the edge 420a is that X₁ does not exceed the threshold designated by the splitting criterion for the root 401 and the splitting condition for the edge 420b is that X₁ exceeds the threshold. In this example, since the actual parameter x₁ (which maps to the formal parameter X₁) is a value selected from the region 451a, x₁ is less than or equal to one. The path through the decision tree 400 therefore proceeds from the root 401 (which is positioned in the first level of the decision tree 400) to the internal node 403a (which is positioned in the second level of the decision tree 400) via the edge 420a.

Next, the actual parameters (x₁, x₂) are compared to the splitting criterion for the internal node 403a. The splitting criterion for the internal node 403a is expressed by the splitting conditions for the edges 420c-d because these are the two edges for which the internal node 403a is the initial vertex, Since the actual parameter x₂ (which maps to the formal parameter X₂) is a value selected from the region 451a, x₂ is less than or equal to one. Therefore, the splitting condition for the edge 420c (i.e., X₂≤1) is satisfied and the splitting condition for the edge 420d (i.e., X₂>1) is not satisfied. As a result, the path through the decision tree 400 proceeds from the internal node 403a (which is positioned at the second level of the decision tree 400) to the leaf 430a (which is positioned in the third level of the decision tree 400) via the edge 420c. The score associated with leaf 430a will therefore be returned when the decision tree 400 is evaluated against a set of actual parameters selected from the region 451a. For this reason, the region 451a is said to map to the leaf 430a. In other words, when the decision tree 400 is evaluated against a set of actual parameters selected from the region 451a, an input data record that comprises this set of actual parameters will “land in” the leaf 430a.

A similar walkthrough can be done for sets of actual parameters selected from each of the regions 451b-e to verify that the region 451b maps to the leaf 430b, the region 451c maps to the leaf 430c, the region 451c maps to the leaf 430c, the region 451d maps to the leaf 430d, the region 451e maps to the leaf 430e, and the region 451f maps to the leaf 430f.

The relationship between the grid 450 and the leaves 430a-f as described above has at least two implications. First, two input data records whose actual parameters are selected from a same region in the grid 450 will “land in” the same leaf—namely, the leaf to which that region maps—and will both be assigned the score associated with that leaf. Second, each threshold designated by a splitting criterion for a node in the decision tree 400 will mark a border between at least two regions in the grid 450 along the dimension (e.g., formal parameter) to which the threshold applies. For example, the splitting criterion for the root 401 designates the number one as a threshold for X₁. As shown in the grid 450, the number one along the horizontal axis (which represents the set of potential values for X₁) marks a solid vertical line that separates the region 451 a from the region 451c, the region 451b from the region 451c, and the region 451b from the region 451d. This vertical border, which is established by a splitting criterion that applies to X₁, extends across the full height of the grid 450. In other words, regardless of the value selected for X₂, the line x₁=1 marks a border between regions. Thus, the status of the solid vertical line x₁=1 as a border is independent of the value selected for X₂. For similar reasons, the solid vertical line x₁=3 marks a vertical border across the full height of the grid 450 regardless of the value selected for X₂.

By contrast, the splitting criterion for the internal node 403a designates the number one as a threshold for X₂. As shown in the grid 450, the number one along the vertical axis (which represents the set of potential values for X₂) marks a horizontal border that separates the region 451a from the region 451b. However, unlike the solid vertical line x₁=1, the solid portion of the horizontal line at x₂=1 does not extend across the full width of the grid 450. Specifically, for values of X₁ greater than one, the dashed portion of the horizontal line x₂=1 does not mark a border between regions. Thus, the status of the horizontal line x₂=1 as a border (i.e., whether it is a solid line or a dashed line) is not independent of the value selected for X₁. Similarly, the horizontal line x₂=2 and the vertical line x₁=2 mark borders that do not fully traverse the grid 450.

This dependence relationship between (i) the status of a threshold designated by a splitting criterion found in the decision tree 400 as a border along the dimension to which the threshold applies and (ii) the value selected for a formal parameter to which the threshold does not apply results from certain structural characteristics of the decision tree 400. First, the leaves 430a-f are distributed across more than one level of the decision tree 400. For example, leaf 430a, leaf 430b, and leaf 430f are positioned in the third level, while leaf 430c is positioned in the fourth level, and leaves 430d-e are positioned in the fourth level of the decision tree 400. Second, although the internal node 403a and the internal node 403b are both positioned in the second level of the decision tree 400, the splitting criterion for the internal node 403a and the splitting criterion for the internal node 403b apply to different formal parameters (X₂ and X₁, respectively). Third, the splitting criterion for the internal node 403a and the splitting criterion for the internal node 403b designate different thresholds (one and three, respectively).

If the decision tree 400 is intended to be used to compute scores alone, the structural characteristics of the decision tree 400 that result in the dependence mentioned above might be of little concern, However, if contribution values for the parameters used by the decision tree 400 are desired in addition to the score that the decision tree 400 computes for an input data record, these structural characteristics pose a problem.

To illustrate this problem, consider the following example. Suppose a first input data record includes actual parameters selected from the region 451c shown in the grid 450. Specifically, suppose that the actual parameter x₁ is greater than one, but less than or equal to two. Also suppose that the actual parameter x₂ is greater than one, but less than or equal to two. Since the region 451c maps to the leaf 430c, the decision tree 400 will return the score associated with the leaf 430c for the first input data record.

Further suppose that a second input data record also includes actual parameters selected from the region 451c. However, for the second input data record, suppose that the actual parameter x₁ is greater than two, but less than three. In addition, for the second input data record, suppose that x₂ is greater than or equal to zero, but less than one. Again, since the region 451c maps to the leaf 430c, the decision tree 400 will return the score associated with the leaf 430c for the second input data record.

Although the first input data record and the second input data record both land in the leaf 430c, they map to subregions of the region 451c (e.g., as shown by the dashed lines that cross the region 451c) that would have been divided by a solid vertical border (marked by the line x₁=1) and by a horizontal border (marked by the line x₂=1) but for the dependence relationship explained above. In cases where two input data records (i) land in the same leaf of a decision tree, yet (ii) map to different subregions of a grid region that maps to the leaf, as discussed above, the contribution values (e.g., game values such as Shapley values and Owen values) for the formal parameters used by the tree will generally not be equal for the two input data records. In other words, although the two input data records land in the same leaf and will be assigned the same score by the decision tree, the two input data records will not have the same contribution values for their respective features. A formal proof of this principle has been provided in Filom et al., “On marginal feature attributions of tree-based models,” digital object identifier (doi): 10.3934/fods.2024021, which is hereby incorporated by reference in its entirety.

Thus, the structural characteristics of the decision tree 400 that result in the dependence relationship explained above render the decision tree 400 insufficient for determining contribution values without additional extrinsic data (e.g., training data) that is not incorporated into the decision tree 400 itself. The methods available for determining contribution values for the decision tree 400 are computationally intensive and have certain drawbacks for some applications that involve determining contribution values for large numbers of input data records.

Filom et al. (cited above) have demonstrated that the type of problematic dependence relationship described above can be eliminated if several specific constraints, discussed in further detail below, on the structural characteristics of a decision tree are satisfied. Filom et al. (cited above) have further demonstrated that the contribution values will be equivalent for each input data record that lands in the same leaf of a decision tree that satisfies these constraints.

Thus, each leaf in a decision tree that satisfies these constraints (e.g., the decision tree is symmetric) maps to a single respective set of contribution values for the formal parameters (e.g., features) the decision tree is configured to receive as input. As a result, sets of contribution values for features can be determined on a leaf-by-leaf basis rather than on an input-data-record-by-input-data-record basis. Effectively, once the set of contribution values for the features for a single input data record that lands in a leaf is known, the set of contribution values for the features for each other input data record that lands in that leaf is also known. This unexpected principle can be leveraged by storing each computed set of contribution values into a data structure that maps leaves to sets of contribution values (e.g., a lookup table or a hash table), Once the set of contribution values to which a leaf maps has been computed and stored in the data structure, the set of contribution values for an input data record that subsequently lands in the leaf can be retrieved via a rapid lookup operation rather than through an arduous series of calculations.

The speed at which a set of contribution values can be retrieved subsequent to computation is not the only way efficiency can be increased, however. Filom (cited above) have also demonstrated that when the problematic dependence relationships described above with respect to FIG. 4 are eliminated, the general formula for determining marginal Shapley values can be simplified such that the computational complexity for determining marginal Shapley values is greatly reduced. Furthermore, the simplified version of the formula does not call for data extrinsic to the decision tree itself (e.g., the training dataset used to train the decision tree or a background data set). Thus, the efficiency of both processor usage (because the complexity reduced) and memory usage (because extrinsic data does not have to be stored or retrieved) can be increased at the computation stage for sets of contribution values as well as the retrieval stage.

The increases in efficiency at the computation stage are such that, in many cases, the sets of contribution values to which the leaves of a decision tree map can be exhaustively calculated before the decision tree is deployed for use so that both scores and contribution values can be returned rapidly for input data records immediately upon deployment of the decision tree.

Nevertheless, if an exhaustive determination of the sets of contribution values to which the leaves map is prohibitively costly (e.g., in terms of memory, processor capacity, or other computing resources) or otherwise not desirable prior to deployment, the data structure for retrieval can be populated piecemeal over time (e.g., each time an input data record lands in a leaf in which no previous input data record has landed, the set of contribution values can be computed and an entry that maps the leaf to the set of contribution values can be added to the data structure).

In light of the advantages described above, it will be illustrative to provide an example in which the specific constraints on the structural characteristics of a decision tree are satisfied such that these advantages can be obtained.

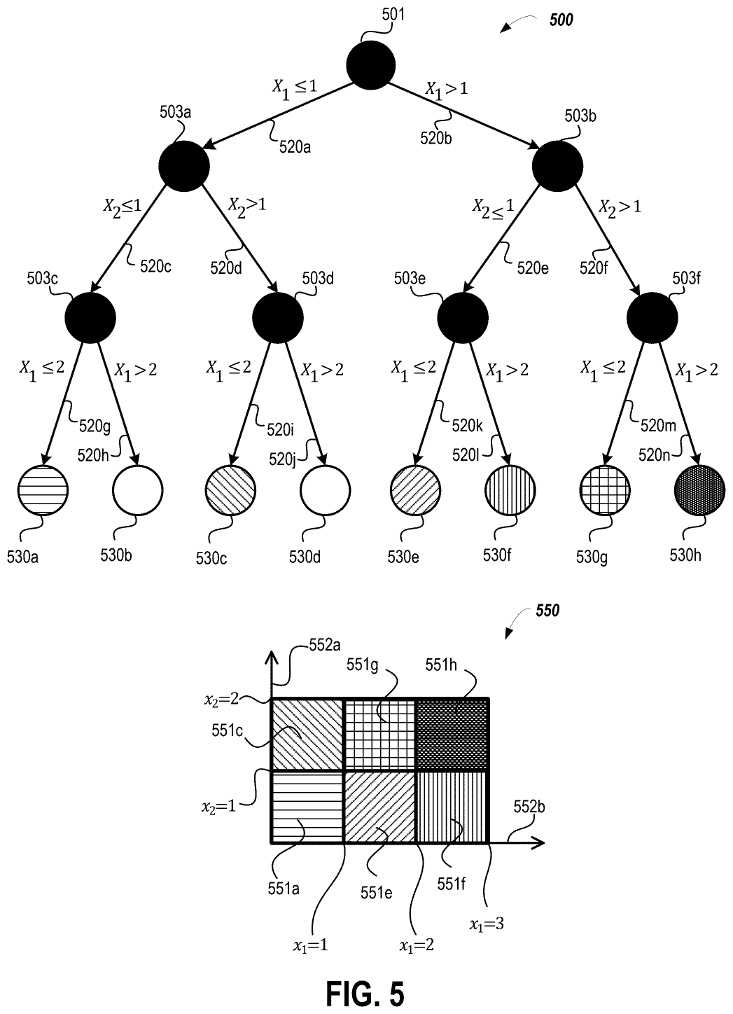

Turning to FIG. 5, a decision tree 500 is depicted along with a grid 550 that illustrates regions that map to the leaves 530a-f of the decision tree 500, according to one example. The inequalities that are shown adjacent to the edges 520a-n of the decision tree 500 represent splitting conditions that will determine the path from the root 501 of the decision tree 500 to one of the leaves 530a-f of the decision tree 500 based on a group of actual parameters included in a given input data record.

With regard to the nomenclature for binary trees that is familiar to those of skill in the art, the decision tree 500 is a “full” binary tree because each node in the decision tree 500 is an initial vertex of zero or two edges. The decision tree 500 is also “balanced” because the height of the left and right subtrees of the root 501 (and the respective left and right subtrees of each of the internal nodes 503a-f) are equivalent. Furthermore, the decision tree 500 is also “complete” because each level of the decision tree 500 is filled. Ultimately, the decision tree 500 is a “perfect” binary tree because the leaves 530a-h are positioned in the same level and each of the internal nodes 503a-f is an initial vertex of two directed edges.

For the purposes of FIG. 5, the group of actual parameters will be denoted as (x₁, x₂) (as was the case for FIG. 4). The formal parameters (e.g., features) that the decision tree 500 is configured to receive as input will be denoted by (X₁, X₂). Each of the actual parameters (x₁, x₂) maps, respectively, to the formal parameter that has a matching subscript.

Like the decision tree 400 shown in FIG. 4, the decision tree 500 is configured to receive two formal parameters as input. The domain of the decision tree 500 is represented in two dimensions by the grid 550. The range of the decision tree 500 is indicated by the regions 551a-f into which the grid 550 is divided.

The vertical axis 552a depicts a set of potential values ranging from zero to two that the actual parameter x₂ may specify for the formal parameter X₂. Similarly, the horizontal axis 552b depicts a set of potential values from zero to three that the actual parameter x₁ may specify for the formal parameter X₁. Note that these sets of potential values do not imply that any upper bounds or lower bounds exist on the possible values that may be specified for the formal parameters (X₁, X₂).

The structural characteristics of the decision tree 500 satisfy the constraints mentioned above such that the advantages mentioned above can be achieved. These constraints will be described in turn. First, within any given level of the decision tree 500, each internal node in the given level specifies the same splitting criterion (e.g., designates the same threshold and applies to the same feature) as the other internal nodes in the given level. For example, in the second level of the decision tree 500, the internal node 503a and the internal node 503b both specify the splitting criterion X₂≤1. In the third level of the decision tree 500, the internal node 503c, the internal node 503d, the internal node 503e, and the internal node 503f each specify the splitting criterion X₁≤2. The fourth level is the last level of the decision tree 500 and contains the leaves 530a-f; there are no internal nodes in the fourth level of the decision tree 500, so there are no criteria to be compared for the fourth level. Of course, there is only one internal node in the first level of the decision tree 500—namely, the root 501—so there are no other nodes in the first level whose criteria can be compared to the criterion specified by the root 501. Since the respective splitting criterion used at each level of the decision tree 500 applies to a single feature, the number of features that the decision tree 500 is configured to receive as input is no greater than the number of levels in the tree. This upper bound on the number of features that may be used by a decision tree of a given depth is helpful for reducing computational complexity. Second, the decision tree 500 is a “perfect” binary tree (i.e., each internal node in the decision tree 500 is an initial vertex of two edges and each leaf in the decision tree 500 is at the same level).

Decision trees that satisfy these two constraints are said to be symmetric (i.e., oblivious). Hence, the decision tree 500 is symmetric, Symmetric decision trees provide the potential for an additional advantage that can be leveraged to increase computational speed in combination with the other advantages discussed herein, as discussed below.

As explained above, the splitting criterion specified in each level of a symmetric decision tree is the same for each node in that level. As a result, each level of the symmetric tree (except the last level, which does not include internal nodes) can be mapped to a single respective threshold and a single respective feature to which that threshold applies.

A first vector of the thresholds to which the levels of the symmetric decision tree map can be generated. The numerical position (e.g., index) of a threshold in the first vector indicates the level of the symmetric decision tree to which that threshold applies. A second vector that identifies the formal parameters to which the thresholds in the first vector apply can also be generated. For example, each entry in the second vector can match the subscript of the formal parameter to which the threshold in the corresponding numerical position in the first vector applies.

When an input data record to be scored by the symmetric decision tree is provided, a third vector can be generated. Each entry in the third vector is the actual parameter (selected from the input data record) that maps to the formal parameter in the corresponding numerical position in the second vector. Once the third vector is generated, a fourth vector that represents the path through the symmetric decision tree between a leaf to the root for the input data record can be generated. The entry for each numerical position in the fourth vector may be a binary value that is determined by comparing the entry at that numerical position in the third vector (which is an actual parameter) to the entry at that numerical position in the first vector (which is a threshold). If the entry in the third vector exceeds the entry in the first vector, the entry in the fourth vector is set to one to signify that the path proceeds through a right edge that proceeds out of a node positioned in the level of the symmetric decision tree that matches the numerical position of the entry. Otherwise, the entry is set to zero to signify that the path proceeds through a left edge that proceeds out of the node positioned in the level of the symmetric decision tree that matches the numerical position of the entry.

Since the splitting criterion for a given level of a symmetric decision tree is the same for each node in that level, the threshold to which a comparison is to be made at any given level is independent of the route of the path through the symmetric decision tree in previous levels. Furthermore, the actual parameter to be compared to the threshold is also independent of the route of the path through the symmetric decision tree in previous levels because the formal parameter to which the threshold applies (and to which the actual parameter maps) is independent of the route of the path through the symmetric decision tree in previous levels. As a result of this independence between the respective splitting criterion for each level and the route of the path through previous levels of the symmetric decision tree, the entries for the fourth vector (which represents the path through the symmetric decision tree for the input data record) can be computed in parallel rather than in series. As a result, the speed to compute the leaf in which the input data record lands can be increased.

Returning to the specific example of the decision tree 500, the relationship between the decision tree 500 and the grid 550 is similar to the relationship between the decision tree 400 of FIG. 4 and the grid 450 of FIG. 4. However, unlike the grid 450, the grid 550 has no dotted line to mark any border because the decision tree 500 is symmetric whereas the decision tree 400 is not. In particular, two input data records whose actual parameters are selected from a same region in the grid 550 will “land in” the same leaf—namely, the leaf to which that region maps—and will both be assigned the score associated with that leaf in the decision tree 500.

Note that there are eight leaves (i.e., the leaves 530a-h) in the decision tree 500, but there are six regions in the grid 550. This is because no possible input data record will land in the leaf 530b or in the leaf 530d. The path from the root 501 to the leaf 530b includes both an edge with the splitting condition X₁≤1 and an edge with the splitting condition X₁>2; there is no possible value for X₁ that can satisfy both of these splitting conditions concurrently. Similarly, the path from the root 501 to the leaf 530d includes these contradictory splitting conditions. For this reason, the leaf 530b and the leaf 530d are said to be non-realizable. By contrast, the leaves 530a, c, e-h are said to be realizable because there are combinations of possible values of X₁ and X₂ that can satisfy the splitting conditions in the respective paths from the root to the leaves 530a, c, e-h. The grid 550 includes a region that maps to each realizable leaf, but does not include any regions that map to non-realizable leaves.

Each threshold designated by a splitting criterion for a node in the decision tree 500 (which is also the splitting criterion for the level in which that node is positioned) marks a border between at least two regions in the grid 550 along the dimension (e.g., formal parameter) to which the threshold applies. For example, the splitting criterion for the root 501 designates the number one as a threshold for X₁. As shown in the grid 550, the number one along the horizontal axis (which represents the set of potential values for X₁) marks a solid vertical line that separates the region 551a from the region 551e and the region 551c from the region 551g. This vertical border, which is established by a splitting criterion that applies to X₁, extends across the full height of the grid 550. In other words, regardless of the value selected for X₂, the line x₁=1 marks a border between regions. Thus, the status of the solid vertical line x₁=1 as a border is independent of the value selected for X₂. For similar reasons, the solid vertical line x₁=2 marks a vertical border across the full height of the grid 550 regardless of the value selected for X₂.

Similarly, the splitting criterion for the internal node 503a designates the number one as a threshold for X₂. As shown in the grid 550, the number one along the vertical axis (which represents the set of potential values for X₂) marks a solid horizontal line that separates the region 551a from the region 551c. Unlike the example shown in FIG. 4, the horizontal line x₂=1 traverses the full width of the grid 550, thereby marking a border between (i) 551a and 551c; (ii) 551e and 551g; and (iii) 551f and 551h. Thus, the status of the horizontal line x₂=1 as a border is independent of the value selected for X₁.

Thus, in the example shown in FIG. 5, there is independence between (i) the status of each threshold designated by a splitting criterion found in the decision tree 500 as a border along the dimension to which the threshold applies and (ii) the value selected for a formal parameter to which the threshold does not apply, This independence results because the decision tree 500 is symmetric (i.e., the structural characteristics of the decision tree 500 satisfy the constraints that apply to symmetric trees, as explained above).

With the examples shown in FIGS. 4-5 and the constraints thus explained, it will be helpful to illustrate how the processes described herein may operate in practice by describing the process in detail for an example decision tree.

Turning to FIG. 6, an ensemble 600 of symmetric decision trees is depicted that will be referenced in the explanation below of a process for determining contribution values for features used on the ensemble 600, according to one example.

Suppose the ensemble 600 is a CatBoost model that has been trained against a training dataset. Also suppose that there are a total of Al trees in the ensemble 600, where M is a positive integer. Let T₁(X), T₂(X), . . . Tₘ(X) denote the trees in the ensemble, where X represents the set of formal parameters (e.g., features, which are stored in a vector in this example) that the ensemble 600 is configured to receive as input, and the subscripts represent indices to identify the individual decision trees within the ensemble 600.

The decision tree 601 is shown as an example of an individual tree. The operations below will be described with respect to the decision tree 601 for the sake of simplicity, but those same operations will be performed for each decision tree in the ensemble 600 during the process of computing contribution values for the features. Persons of skill in the art will understand that at least some of the operations and other actions described below may be performed in orders other than the order provided in this example.

The process may commence by identifying the realizable paths through the decision tree 601 and storing a collective representation of those paths in a matrix. A single path through the tree may be represented by a vector of binary values. In one example, suppose there are n levels in the decision tree 601, where the root 602 is in the first level and the leaves of the decision tree 601 are in the n^{th} level. In this example, the numerical position (e.g., index) of an entry in the vector may be defined as n minus the level of the decision tree 601 to which the entry maps. An entry with a binary value of one at an index j in the vector signifies that the path represented by the vector includes a right edge that points to a node positioned in the (n−j)^{th} level of the decision tree 601. In contrast, an entry with a binary value of zero at the index j in the vector signifies that the path represented by the vector includes a left edge that points to the node positioned in the (n−j)^{th} level of the decision tree 601. Since other vectors described below will also include binary values, a vector that represents a path will be called a path vector. (For example, given a path a, the example equation a=(1,0,0,1,0) would indicate that the path vector (1,0,0,1,0) represents the path a through a binary tree of depth 5.) Each path vector for a realizable path through the decision tree 601 is stored as a row of a matrix of paths that will be called the path matrix.

Next, a probability estimate is determined for each realizable leaf in the decision tree 601. Let Rₐ denote the realizable leaf that is connected to the root 602 of the decision tree 601 by the path a. The probability [symbol] for the realizable leaf Rₐ (and therefore the probability assigned to the path a) can be estimated (the estimate is represented by [symbol] ) by dividing the number of training instances (e.g., input data records used for training, which may be) in the training dataset that landed in the realizable leaf during training of the decision tree 601 by the number of training instances in the training dataset, as indicated by the equation below:

$$( X ∈ {R}_{a} ) \approx \frac{number of training instances that landed in {R}_{a}}{number of training instances in the training set} = ( X ∈ {R}_{a} ) ,$$

where X∈Rₐ denotes the proposition that a set of actual parameters that map to the features in the vector X lands in the realizable leaf Rₐ.

Given that the ensemble 600 is a CatBoost model in this example, one characteristic of the decision tree 601 and the other member trees of the ensemble 600 is that each member tree is configured to use a (usually small) subset of the features that the ensemble 600 is configured to receive as input. Suppose there are n features that the ensemble 600 is configured to receive as input, where n is a positive integer. Also suppose that N denotes the set of the features that the ensemble 600 is configured to receive as input. In other words, N is the set of global features for the ensemble 600. The cardinality (i.e., number of elements in a set) of N is denoted by |N| and is equal to n. Further suppose that K denotes the set of features on which the decision tree 601 splits and that k denotes the number of features in K (which can also be represented by |K|, which is the cardinality of K). Because the features on which the decision tree 601 splits are selected from the set of the features that the ensemble 600 is configured to receive as input, the features in K represent features that are also found in N. In that sense, the set of features represented in K is a subset of the set of features represented in N. Note, however, that depending on the forms in which N and K are implemented in programming code, there might not be a self-evident way to identify to which feature in N a given feature in K corresponds. For instance, consider an example in which N is implemented as vector (or an array or some other data structure that stores multiple values, assigns a respective numeric index to each given value, and returns the given value in response to receiving the respective numeric index assigned the given value as an argument (e.g., an actual parameter)). In this example, if K is also represented as a vector and K does not include most of the features included in N, the index assigned to a particular feature in the vector that implements K might not match the index assigned to that particular feature in the vector that implements N. To facilitate implementation of the techniques described further below in programming code, it may be advantageous to identify the feature in N to which a feature in K corresponds. Accordingly, an injective function that maps features in K to features in N (e.g., such as the local-to-global mapping that will be described further below) may be defined for this purpose.

Regarding k, k is a positive integer that is less than or equal to n. K constitutes the set of local features for the decision tree 601. The case k=n would rarely be implemented in practice because it would be likely to cause overfitting. (Note that k is not allowed to exceed the depth of the tree; in practice, it may be preferable to constrain the depth of the tree to no more than fifteen.) For that reason, suppose that k<n (i.e., K is a proper subset of N) for the purposes of this example.

The features in K were selected (e.g., randomly or by an optimization mechanism applied during training) from N. As a result, the indices that map to the features in a vector that stores the elements of K (i.e., the local features for the decision tree 601) typically will not match the indices of those same features in a vector that stores the elements of N (i.e., the global features for the ensemble 600). As will be shown further below, it is useful to create local-to-global mapping that maps the indices of local features in the vector that stores K to the indices of those same features in the vector that stores N. The local-to-global mapping can be stored in a data structure such as a lookup table.

Next, for each feature i in K, the set of the levels of the decision tree 601 for which i is the feature to which the splitting criterion for the level applies is identified. In other words, if the splitting criterion for a level of the decision tree 601 applies to i, that level is included in the set of levels for i. The set of levels for i is denoted by [symbol] (i). The set of levels [symbol] (i) may be stored by a vector that contains the indices of the elements of [symbol] (i) (e.g., the depths of the levels in [symbol] (i)) in the decision tree 601. The set of the sets [symbol] (i) for each feature i in K is denoted by p. For reference, Filom et al. (cited above) refer to sets of levels as partitions of levels (i.e., level partitions) and also uses [symbol] (i) and [symbol] to represent the set of levels for i and the set of sets of levels of i, respectively. For disambiguation purposes, note that level partitions (which refer to sets of levels) differ from the partitions of features (e.g., global partitions and tree-local partitions) that will be discussed further below with respect to determining Owen values.

In this example, suppose the contribution values to be determined are Shapley values. The generalized formula for computing Shapley values is given by

$${ϕ}_{i} [ {v}^{M E} , N ] = {\sum }_{S ⊆ N ∖ \{ i \}} w ( s , n ) ( {v}^{M E} ( S ⋃ \{ i \} ) - {v}^{M E} ( S ) ) , S ⊆ N ,$$

where ϕᵢ[v^{ME}, N] represents the Shapley value for the feature i, S represents a proper subset of N that does not include the feature i, s represents the number of elements in S (i.e., the cardinality of S), w(s,n) represents a known weight value, {i} represents the set of features containing i alone and no other elements, and V^{ME}(S∪{i}), where dependence on parameters (x, X, f) is suppressed as indicated above, represents a game based on marginal expected values of the decision tree 601. In this context, the term “game” refers to a game as defined in game theory, as will be recognized by persons of skill in the art. In the game v^{ME}, the features in N are considered to be the players (as defined in game theory); the payoffs and rules (as defined in game theory) are established by the structure of the decision tree 601.

In this example, it will be useful to provide notations for some additional quantities that will be computed during the process of determining Shapley values for the leaves in the decision tree 601. Let b denote a path. As noted above, a also denotes a path. For the pair of path a and path b, which is denoted by (a, b), it will be helpful to identify a subset of the set of features K that highlights similarities between how the feature i influences path a and how the feature i influences path b. Specifically, it will be helpful to know at which levels path a and path b have matching path directions. In this context, there are two scenarios in which path a and path b are considered to have a matching path direction at a given level of the decision tree 601. In the first scenario, (i) path a proceeds to the next level in the decision tree 601 through a left edge of the node through which path a passes in the given level and (ii) path b proceeds to the next level in the decision tree 601 through a left edge of the node through which path b passes in the given level. In the second scenario, (i) path a proceeds to the next level in the decision tree 601 through a right edge of the node through which path a passes in the given level and (ii) path b proceeds to the next level in the decision tree 601 through a right edge of the node through which path b passes in the given level.

In other words, in the first scenario, both path a and path b proceed to a left subtree of a node in the given level. Path a and path b may or may not pass through the same node of the given level to the same subtree, but path a and path b are considered to have a matching path direction in either case as long as they both proceed via a left edge for which a node in the current level is the initial vertex. Similarly, in the second scenario, both path a and path b proceed to a right subtree of a node in the given level. Path a and path b may or may not pass through the same node of the given level to the same subtree, but path a and path b are considered to have a matching path direction in either case as long as they both proceed via a right edge for which a node in the current level is the initial vertex.

With the meaning of the phrase “matching path directions” thus explained, a subset of levels that reflects commonalities between how the features in K influence two paths is defined in the equation below:

$$ℰ ( a , b ) := \{ j ∈ K : {( j )}_{} = {( j )}_{} \} ,$$

where j denotes a feature in K, [symbol] ₍ⱼ₎ denotes the splitting directions of the path b at levels of the decision tree 600 that map to respective splitting criteria that apply to the feature j, [symbol] ₍ⱼ₎ a denotes the splitting directions of the path a at levels of the decision tree 600 that map to respective splitting criteria that apply to the feature j, and ε(a, b) denotes the set of pairs of paths for which path a and path b have matching path directions at each level that map to a splitting criterion that applies to the feature j. Note that ε(a, b) will be the empty set if there is no feature j in K for which path a and path b have matching path directions. Also note that ε(a, b) will be equivalent to K if path a equals path b. Of course, depending on which paths are selected as path a and path b, the number of features in ε(a, b) can also be greater than zero or less than the number of features in K.

It will be also be helpful to define an additional set of pairs of paths according to the following equation:

$$C ( a , Z , W ) = \{ ( b , u ) : ℰ ( a , b ) = W , ℰ ( b , u ) = - Z \} , Z ⊆ W ,$$

where W denotes a subset of K (i.e., the set of local features for the decision tree 601), Z denotes a subset of W, \tilde{Z} denotes the set of features that are in K but are not in Z, u denotes a path, (b, u) denotes a pair of paths, and C(a, Z, W) denotes the set of pairs of paths that conform to the definition established by the equation above (which specifies that (i) the set of pairs of paths ε(a, b) is W; and (ii) the set of pairs of paths ε(b, u) is −Z).

Given the equations and definitions provided above, and as explained in greater detail by Filom et al. (cited above), the generalized formula for computing a Shapley value can be reduced to a formula designed specifically to compute the Shapley value for a feature i for a leaf a in the decision tree 601, as shown in the equation below:

$${ϕ}_{i} ( a ) = ( {\sum }_{W ⊆ K} {\sum }_{Z ⊆ W , Z ∋ i} {w}_{+} ( w , z ) {\sum }_{( b , u ) ∈ C ( a , W , Z )} {c}_{b} {p}_{u} ) - ( {\sum }_{i ∉ W} {\sum }_{Z ⊆ W} {w}_{-} ( w , z ) {\sum }_{( b , u ) ∈ C ( a , W , Z )} {c}_{b} {p}_{u} ) ,$$

where w₊(w,z) denotes a weight that is a functional of the weight w(s,n) (defined above) and is known when w(s,n) is known, w₋(w,z) also denotes a weight that is a functional of the weight w(s,n) (defined above) and is known when w(s,n) is known, z denotes the number of features in Z (i.e., the cardinality of Z), c_{b} denotes the value associated with the leaf Rb in the decision tree 601 (i.e., the value the decision tree 601 will assign to an input data record that lands in the leaf R_{b}), pᵤ denotes the probability estimate [symbol] (X∈Rᵤ) for Rᵤ, and ϕᵢ(a) denotes the Shapley value for the feature i for the leaf a in the decision tree 601.

The formula ϕᵢ(a) reduces the computational complexity of determining a Shapley value for a feature i for a leaf a in the decision tree 601 to such an extent that it may be practical and desirable to compute the set of Shapley values for the features N of the ensemble 600 for each leaf that is found in the member trees of the ensemble 600. One advantage that results from computing the Shapley values beforehand in this manner is that the Shapley values can be stored in a data structure that maps leaves to their corresponding sets of Shapley values. Once the data structure is populated, the sets of Shapley values for an input data record can be retrieved rapidly from the data structure based on the leaves in which the input data record lands in the decision trees found in the ensemble 600. The overall Shapley value for a feature for the ensemble 600 can be computed by summing the Shapley values for that feature for the decision trees found in the ensemble 600.

To evaluate the formula for ϕᵢ(a) for a given path a (and the leaf indicated thereby) and a given feature i, it will be useful to identify a set of paths referred to herein as a path preimage for the path a. The path preimage for the path a and a subset of K is defined in the equation below:

$${ℰ}^{- 1} ( a , W ) = \{ b : ℰ ( a , b ) = W \} ,$$

where a denotes the path, b denotes a path such that the condition ε(a, b)=W is satisfied, W denotes a subset of K (i.e., the set of local features for the decision tree 601), and ε(a, b) denotes a subset of features as explained above. The path preimages for the path a and each possible value of W are computed and stored (e.g., in a matrix of path preimages for the path a). If sets of contribution values for features are to be precomputed for storage in a data structure for subsequent lookup, the path preimages for each path from the root to a leaf of the decision tree 601 paired with each possible value of W (i.e., each possible combination of a and W) can be computed and stored.

Notably, the number of elements in the path preimage ε⁻¹(a,W) for the path a is independent of a. Rather, the number of elements in the path preimage ε⁻¹(a,W) is dependent only on W. Moreover, for every fixed realizable path a, the collection of path preimages {ε⁻¹(a,W)}_{W⊆K} partitions the set of all realizable paths into disjoint parts. Thus, for every fixed realizable path a

$${\sum }_{W ⊆ K} \vert {ε}^{- 1} ( a , W ) \vert = ℒ ,$$

where [symbol] is the number of realizable paths. Thus, the path preimages for the possible values of W and every path a can be stored together in a matrix size [symbol] times [symbol] .

Note that the priority application U.S. patent application Ser. No. 18/499,974 used the symbol [symbol] (a,W) to refer to the path preimage for the path a and a subset of K. The current application has changed the symbol used to refer to the path preimage from [symbol] (a,W) to ε⁻¹(a,W) so that the symbol [symbol] may be used to refer to partitions in the discussion of Owen values further below without causing confusion. In addition, the priority application used the word “preimage” alone to refer to the path preimage. The current application has added the adjective “path” to “preimage” to distinguish the path preimage from other types of preimages which will be discussed further below with respect to Owen values.

Once the path preimages have been computed, it will be useful to compute probabilities for the path preimages (i.e., the path preimage probabilities). The probability of a path preimage is defined by the equation below:

$${p}_{pre} ( a , W ) = ℙ ( X ∈ {⋃}_{b ∈ 𝒫 ( a , W )} {R}_{b} ) = {\sum }_{b ∈ {ε}^{- 1} ( a , W )} {p}_{b} ,$$

where p_{Pre}(a,W) denotes the probability of the path preimage ε⁻¹(a,W), [symbol] denotes a probability estimate (as defined above), R_{b} denotes the realizable leaf that is connected to the root 602 of the decision tree 601 via the path b, p_{b} denotes the probability estimate for R_{b}, and ∪_{b∈ε}_{^{−1}}_{(W,a)}R_{b} denotes a set (e.g., a union set) that includes each leaf that is connected to the root 602 via a path that is in the path preimage ε⁻¹(a,W). As shown, the path preimage probability is ultimately the sum of the probability estimates for the paths included in the path preimage.

Once the path preimage probabilities have been computed, marginal path expectations can be computed. The marginal path expectation for the path a and the set of features W is defined by the equation below:

$$mp ( a , W ) = {( {c}_{a} \cdot {{p}_{pre} ( a , W )}^{T} )}^{T} ,$$

where mp(a,W) denotes a marginal path expectation, cₐ denotes the score associated with the leaf a (i.e., the score that the decision tree 601 will assign to an input data record that lands in the leaf R_{b}), and the use of T in superscript denotes transposing the operand that immediately precedes T (which presumes that the path preimage probabilities pₚᵣₑ(a,W) are stored as a vector).

A marginal path expectation can be interpreted as an updated expected value for the leaf Rₐ that is computed by using the probability of the path preimage in place of the probability estimate for the leaf Rₐ. Functionally, the process of computing a marginal path expectation can be described as identifying the hyperplanes in the multidimensional space of the domain that bound the region of the domain that maps to the leaf Rₐ.

With the marginal path expectations thus defined, for a given feature i and a given path a, the simplified formula for computing Shapley values can be rewritten as shown in the equation below:

$${ϕ}_{i} ( a ) = ( {\sum }_{W ⊆ K} {\sum }_{Z ⊆ W , Z ∋ i} {w}_{+} ( w , z ) ( {\sum }_{b ∈ {ε}^{- 1} ( a , W )} mp ( b , - Z ) ) ) - ( {\sum }_{i ∉ W} {\sum }_{Z ⊆ W} {w}_{-} ( w , z ) ( {\sum }_{b ∈ {ε}^{- 1} ( W , a )} mp ( b , - Z ) ) ) ,$$

where w₊(w,z) denotes a weight that is a functional of the weight w(s,n) (defined above) and is known when w(s,n) is known, w₋(w,z) also denotes a weight that is a functional of the weight w(s,n) (defined above) and is known when w(s,n) is known, z denotes the number of features in Z, where W denotes a subset of K (i.e., the set of local features for the decision tree 601), Z denotes a subset of W, and −Z denotes the set of features that are in K but are not in Z.

With the marginal path expectations computed and the weights known, the formula ϕᵢ(a) can be evaluated for each feature i for the leaf a into which an input data record falls in the decision tree 601. The formula ϕᵢ(a) can be similarly evaluated for each feature i for each leaf into which the input data record falls in the other decision trees of the ensemble 600. The sum of the Shapley values for a feature i across the leaves in the ensemble 600 into which the input data record lands can then be summed to determine the overall Shapley value for the ensemble 600.

The formula ϕᵢ(a) can also be evaluated to determine each of the features to determine the respective set of Shapley values to which each leaf in the ensemble 600 maps. The determined Shapley values can then be stored in a data structure that maps leaves to sets of Shapley values to facilitate rapid retrieval and to obviate repeating any calculations when Shapley values are requested for input data instances provided thereafter.

As explained above, the simplified formula for computing Shapley values can be evaluated with greatly increased computational efficiency using path preimages and marginal path expectations in the manner described above. In cases where the features used in an ensemble of decision trees (e.g., a CatBoost model) are statistically independent of each other, Shapley values may serve as valuable indicators of the extent to which each of the corresponding values for those features (e.g., the actual parameters that map to those features) influenced the classification of a given input data record via the ensemble. In other cases, some of the features that an ensemble of decision trees is configured to receive as input might not be statistically independent of each other.

In such cases where the premise of statistical independence between features is not satisfied, there are advantages to using Owen values instead of Shapley values because Owen values are determined in a manner that accounts for the dependencies that exist between features.

The formula for the Owen value Owᵢ[v] is similar to the Shapley value formula (see [0055]), but also incorporates a partition as shown below:

$${Ow}_{i} [ v ] = {\sum }_{R ⊆ M \backslash \{ j \}} {\sum }_{T ⊆ {S}_{j} \backslash \{ i \}} \frac{\vert R \vert ! ( \vert M \vert - \vert R \vert - 1 ) !}{\vert M \vert !} \text{} \frac{\vert T \vert ! ( \vert {S}_{j} \vert - \vert T \vert - 1 ) !}{\vert {S}_{j} \vert !} \text{} ( v ( ( {⋃}_{r ∈ R} {S}_{r} ) ⋃ T ⋃ \{ i \} ) - v ( ( {⋃}_{r ∈ R} {S}_{r} ) ⋃ T ) ) ,$$

$$𝒫 = \{ {S}_{1} , … , {S}_{m} \}$$

$$a partition of$$

$$N = \{ 1 , … , n \}$$

$$indexed by elements of$$

$$M = \{ 1 , … m \} ,$$

$$and$$

$$i ∈ {S}_{j} .$$

However, the formula for determining Owen values includes additional terms to account for dependencies between features. To evaluate these additional terms, additional computations generally have to be performed. If these additional computations are coded in a brute-force manner that naïvely translates the summation terms in a generalized formula for determining Owen values into computer code, inefficiency results because many of the additional computations will be repeated. Such inefficiency may render it impractical to determine Owen values in a deployed system for classifying input data records.

As will be explained in greater detail below, techniques described herein can be applied to determine Owen values in a manner that is computationally efficient enough to be used in a deployed system for classifying input data records via an ensemble of symmetric decision trees. These techniques involve storing the results of intermediate computations in additional data structures that will be described below. This obviates the inefficiency that would result from naïve approaches that would involve repeating those intermediate computations by allowing the stored results to be retrieved rather than recomputed throughout the process of determining the Owen values for the features.

To elucidate the techniques described herein for determining Owen values, it will be helpful to begin by defining the symbols and notations that will be used to facilitate the explanation below. First, let (X₁, . . . X) represent a vector of features that an ensemble of symmetric decision trees (e.g., a CatBoost model) is configured to receive as input. The features in the vector (X₁, . . . Xₙ) and their respective indices will be referred to hereafter as the global features and the global indices, respectively. This will help to distinguish the global features and global indices from local features and local indices that will be described with respect to individual decision trees further below.

To facilitate implementation of the techniques described below in programming code, it will be helpful to use the global indices of the global features in the vector (X₁, . . . Xₙ) to represent the global features themselves because the global indices may be stored as integers (e.g., because many programming languages can store integers via a native data type). For this reason, let N represent the set of global indices {1, . . . , n} of the global features, where each global index represents the respective global feature to which it corresponds in the vector (X₁, . . . Xₙ).

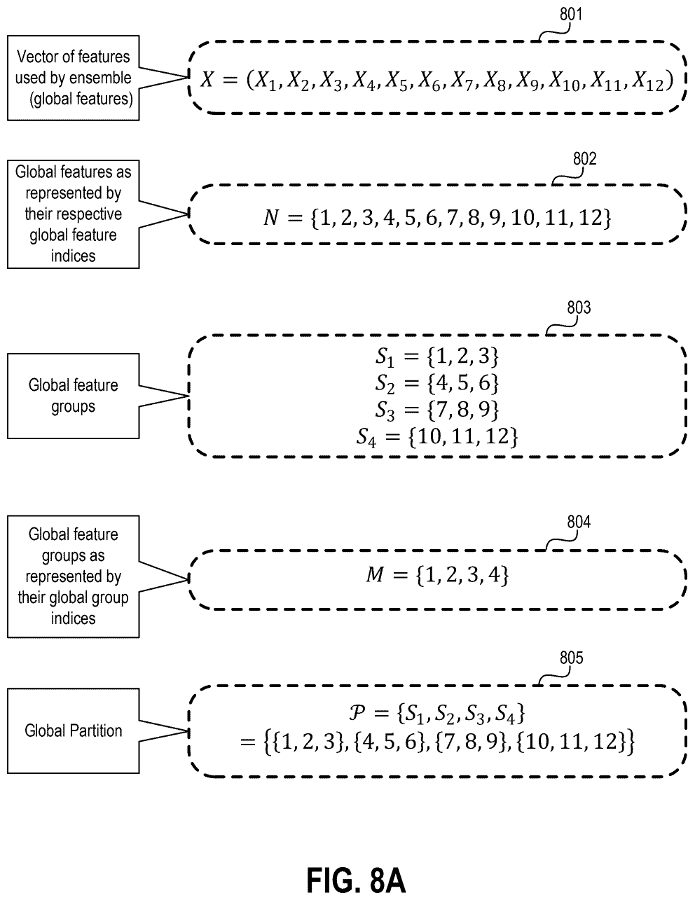

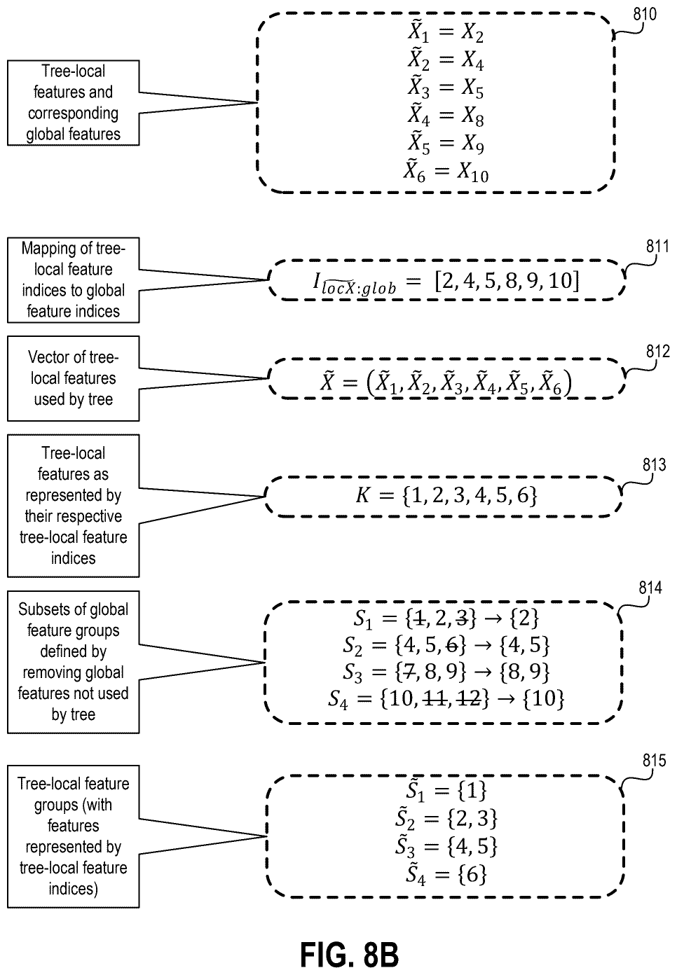

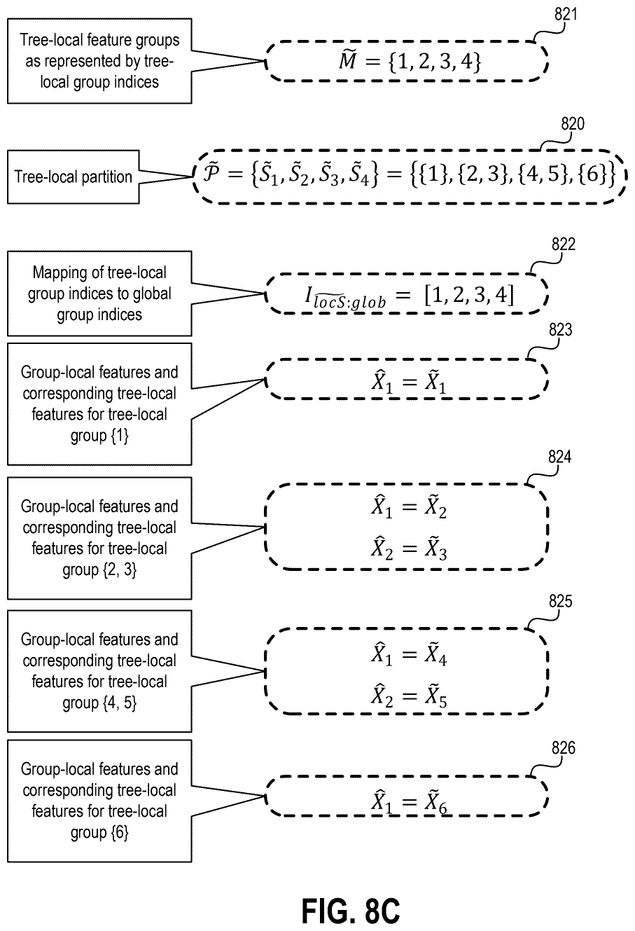

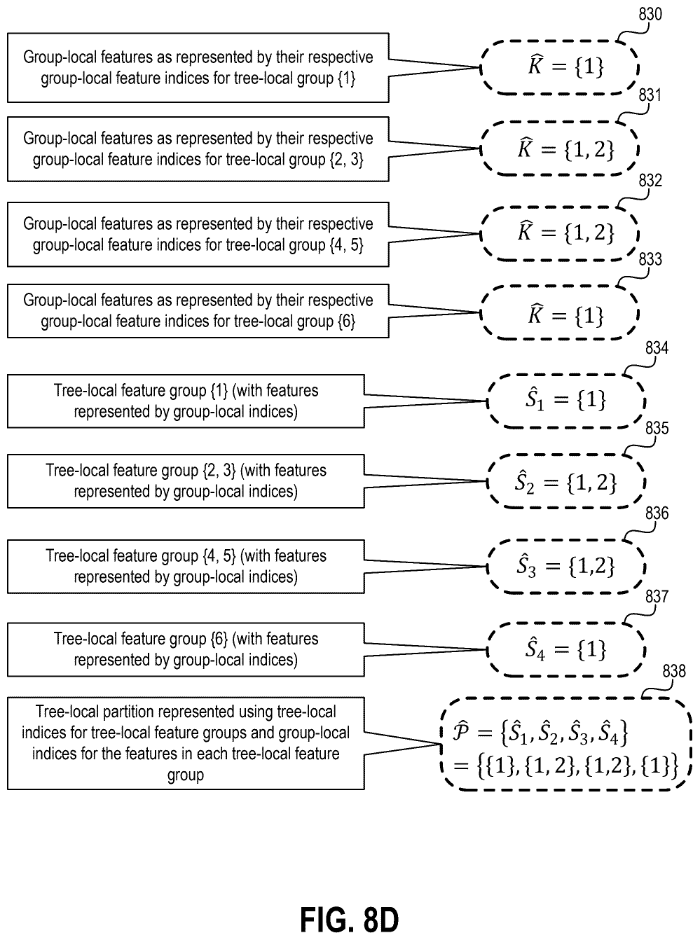

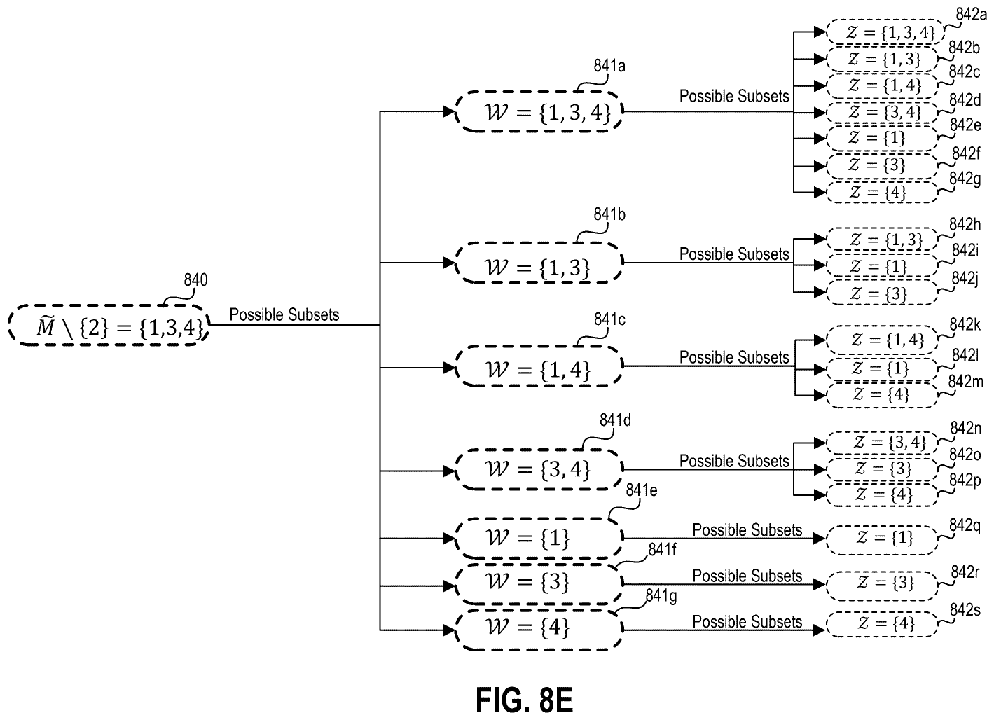

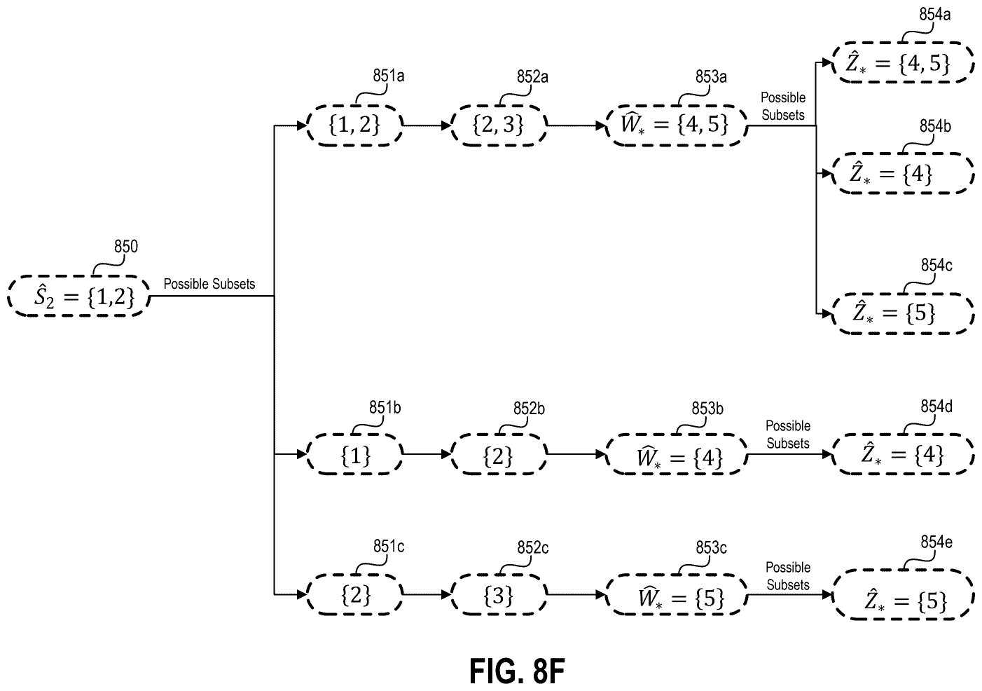

Next, let the global features represented by the global indices in N be partitioned into a set of m global feature groups, where m is a positive integer that is less than or equal to n (note that, in a case where m=n, the Owen values and the Shapley values for the global features will be equivalent). Each global feature group may, for example, comprise features that are not statistically independent of each other (e.g., as determined by applying a clustering technique or some other type of statistical technique). Let [symbol] represent the set (i.e., global partition) of global feature groups {S₁, . . . Sₘ}, where m is a positive integer that represents the number of global feature groups in the global partition. Again, to facilitate implementation of the techniques described below in programming code, it will be helpful to use the global indices of the global feature groups to represent the global feature groups themselves because the global indices may be stored as integers. For this reason, let M represent the set of global indices {1, . . . , m} of the global feature groups, where each global index represents the respective global feature group to which it corresponds in the set {S₁, . . . Sₘ}. For reference, FIG. 8A (which will be discussed further below) provides an illustrative example of feature groups in a global partition.

In general, a given decision tree in the ensemble will not use the entire set of global features that the ensemble is configured to receive as input. Instead, the given decision tree will use a subset of the global features as a basis for splitting criteria included in the levels of the given decision tree. For any particular global feature that is not used in the given decision tree, the Owen value for the particular global feature for any leaf in the given decision tree will be zero—this can be demonstrated a priori without performing any computations for the particular global feature for the given decision tree. For this reason, for the given decision tree, it is advantageous not to perform any computations for (i) global features not used in the given decision tree and (ii) global feature groups that do not include any global features used in the given decision tree (e.g., to avoid inefficient use of memory, processing cycles, etc.).

To ensure that such unnecessary computations are not performed, it will be helpful to define a partition [symbol] that is local to the given decision tree. Hereafter, [symbol] will be referred to as the tree-local partition. In general throughout the discussion that follows, the tilde diacritic mark will be used to distinguish tree-local elements from global elements (e.g., the tree-local partition [symbol] from the global partition [symbol] ). Each tree-local feature group in the tree-local partition [symbol] is a subset of a corresponding global feature group that includes at least one global feature used by the given decision tree. However, each given tree-local feature group in the tree-local partition [symbol] includes the global feature(s) in the corresponding global feature group that are used in the given decision tree, but excludes any global features in the corresponding global feature group that are not used by the given decision tree. Furthermore, the tree-local partition [symbol] does not include any tree-local feature groups that correspond to any global feature groups that do not include any features used by the given decision tree. As a result, the local partition [symbol] effectively distills the global partition [symbol] down to feature groups and features that are pertinent to the given tree.

Since the given tree might not include corresponding tree-local feature groups for some of the global feature groups, if the tree-local partition [symbol] were to use the global indices of the corresponding global feature groups to indicate the tree-local feature groups, the global indices included in the tree-local partition [symbol] might not be consecutive.

To facilitate implementation of the techniques described further below (e.g., in programming code), it may be helpful to represent the tree-local partition [symbol] by using consecutive tree-local indices to indicate the tree-local feature groups (e.g., so that a loop control variable in programming code can readily iterate through the indices of the tree-local feature groups). Therefore, the tree-local partition [symbol] may be represented as {\tilde{S}₁, . . . \tilde{S}_{\tilde{m}}}, where \tilde{m} is a positive integer that represents the number of tree-local feature groups included in the tree-local partition [symbol] . Note that \tilde{m}≤m because each tree-local feature group corresponds to a respective global feature group.

Furthermore, if the tree-local feature groups were to use the global indices of the features to indicate which features are included in each tree-local feature group, the global indices used to indicate the features in a given tree-local feature group might not be consecutive.

Again, to facilitate implementation of the techniques described further below (e.g., in programming code), it may be helpful to assign additional tree-local indices to the features that are collectively found in the tree-local feature groups (e.g., so that a loop control variable in programming code can readily iterate through the features used in the given tree). The tilde diacritic used for the tree-local feature groups \tilde{S}₁, . . . \tilde{S}ₘ in the tree-local partition [symbol] may, in addition to signifying that the tree-local groups have been assigned tree-local indices, also signifies that the features collectively included in the tree-local feature groups \tilde{S}₁, . . . \tilde{S}_{\tilde{m}} have also been assigned tree-local indices such that, for the given tree, the tree-local index for a given feature identifies the given feature. The set of tree-local indices for the features used in the given tree may be represented by K={1, . . . , k}, where each tree-local index represents a respective feature used in the given tree. For reference, FIGS. 8B-C (which will be discussed further below) provide an illustrative example of tree-local feature groups in a tree-local partition.

In addition assigning tree-local indices to tree-local groups and to features used in the given tree, it may be helpful to assign group-local indices to the features within each tree-local feature group. This may facilitate implementing the techniques described further below (e.g., in programming code) because it may allow a loop control variable to begin at a default starting value (e.g., one or zero) for the group-local index of a first feature in a tree-local feature group and iterate through the features in that tree-local group. By contrast, if the tree-local indices for the features in the tree-local group were to be used, additional coding may have to be done to ensure that a loop control variable would begin at the value of the correct tree-local index (which would be different for each tree-local group).

Given the advantages described above that result from using tree-local indices and group-local indices, let \hat{P} represent the tree-local partition [symbol] by using tree-local indices for tree-local feature groups and group-local indices for the features found within each tree-local feature group. In general throughout the discussion that follows, the circumflex diacritic (e.g., as included in \hat{P}) will be used to distinguish the representation that use group-local indices from representations that do not. For example, the tree-local partition [symbol] may also be written as {Ŝ₁, Ŝ₂, . . . , Ŝ_{\tilde{m}}}, where the circumflex diacritic signifies that each of the tree-local groups Ŝ₁,Ŝ₂, . . . , Ŝ_{\tilde{m}} uses group-local indices to identify the features included therein.

The tree-local indices for the tree-local feature groups, the tree-local indices for the features used in the given tree, and/or the group-local indices for the features used in the given tree may facilitate rapid computation of the Owen values for leaves of the given tree for the features used in the given tree. However, since Owen values for leaves of the given tree will also be summed with Owen values for leaves of other trees in the ensemble, it will be helpful to define a mapping that maps tree-local indices and/or group-local indices used in the tree-local partition [symbol] to the global indices for the corresponding global feature groups and/or features. Let I_{loc:glob} represent such a mapping for the given decision tree. The mapping I_{loc:glob} will allow a computing platform that implements the techniques described herein to transform the tree-local and/or group-local indices used for the tree-local partition of the given decision tree and tree-local and/or group-local indices used by other trees to their corresponding global indices so that summation of Owen values across the leaves into which a given input instance lands in the ensemble can be performed rapidly and accurately. For reference, FIGS. 8C-D (which will be discussed further below) provide an illustrative example of a tree-local partition represented using tree-local indices for tree-local feature groups and group-local indices for the features in each tree-local feature group.

With the symbols and notations above thus defined, the Owen value h for a path a (and the leaf indicated thereby) for a feature i (where i represents the respective global index of a given global feature) that is included in a tree-local feature group Ŝⱼ of a tree-local partition [symbol] for the given decision tree may be represented by the expression h_{i∈Ŝ}_{ⱼ}(a) (where j represents the tree-local index for the tree-local feature group Ŝⱼ in the tree-local partition [symbol] ). (Note that the feature i is considered to be included in the tree-local feature group Ŝⱼ if a group-local index included in the tree-local feature group Ŝⱼ maps to i in the mapping I_{loc:glob} for the given tree.) The inventors have shown, in Filom et al. (cited above), that the following formula can be used to compute the Owen-like value h_{i∈Ŝ}_{ⱼ}(a):

$${h}_{i ∈ {\hat{S}}_{j}} ( a ) = {\sum }_{𝒵 ⊆ ⊆ \tilde{M} \backslash \{ j \}} {α}_{1} ( \vert Z \vert , \vert \tilde{M} \vert + \vert Z \vert - \vert \vert ) \cdot {Δ}_{i} ,$$

Where Δᵢ is the difference between a minuend δ₁ and a subtrahend δ₂ (i.e., Δᵢ=δ₁−δ₂). The minuend is defined as:

$${δ}_{1} = {\sum }_{{\hat{Z}}_{*} ⊆ {\hat{W}}_{*} ⊆ {\hat{S}}_{j} , i ∈ {Z}_{*}} {α}_{2} ( \vert {\hat{Z}}_{*} \vert - 1 , \vert {\hat{S}}_{j} \vert + \vert {\hat{Z}}_{*} \vert - \vert {\hat{W}}_{*} \vert ) {\sum }_{Z ∈ Int ( 𝒵 , {Z}_{*} , j , 𝒫 ) , W ∈ Inc ( , {W}_{*} , j , 𝒫 )} ( {\sum }_{b ∈ {ε}^{- 1} ( a , W )} mp ( b , - Z ) )$$

The subtrahend is defined as:

$${δ}_{1} = {\sum }_{{\hat{Z}}_{*} ⊆ {\hat{W}}_{*} ⊆ {\hat{S}}_{j} , i ∉ {W}_{*}} {α}_{2} ( \vert {\hat{Z}}_{*} \vert , \vert {\hat{S}}_{j} \vert + \vert {\hat{Z}}_{*} \vert - \vert {\hat{W}}_{*} \vert ) {\sum }_{Z ∈ Int ( 𝒵 , {Z}_{*} , j , 𝒫 ) , W ∈ Inc ( , {W}_{*} , j , 𝒫 )} ( {\sum }_{b ∈ {ε}^{- 1} ( a , W )} mp ( b , - Z ) )$$

The formula shown above for computing the Owen-like value h_{i∈Ŝ}_{ⱼ}(a) is in the form of an outer sum with a summand that is defined as a product of (i) a multiplicand α₁(|Z|, |\tilde{M}|+|Z|−|W|) and (ii) a multiplier that is the difference Δᵢ.

As indicated by the bounds of the outer sum, W represents a subset of \tilde{M} (recall that \tilde{M} represents the set of tree-local indices {1, . . . , \tilde{m}} of the tree-local feature groups for the given tree, where each tree-local index represents the respective tree-local feature group to which it corresponds in the local partition [symbol] ={Ŝ₁, Ŝ₂, . . . , Ŝ_{\tilde{m}}}). Specifically, [symbol] is a subset of \tilde{M}\{j}. In this context, the expression \tilde{M}{j} indicates the subset of \tilde{M} that includes each element (e.g., tree-local index and/or tree-local group represented thereby) of \tilde{M} except j. Recall that j represents the tree-local index for the tree-local feature group Ŝⱼ in the tree-local partition [symbol] , so W represents a subset of M that does not include j.

Further, Z represents a subset of W. Thus, both Z and W are sets of tree-local indices that do not include the tree-local index j, where each tree-local index represents a respective corresponding tree-local feature group for the given tree. The cardinality of Z (i.e., the number of tree-local indices corresponding to tree-local feature groups in Z) is indicated by the expression |Z|. Similarly, the cardinality of W (i.e., the number of tree-local indices corresponding to tree-local feature groups in W) is indicated by the expression |W| and the cardinality of \tilde{M} (i.e., the number of tree-local indices corresponding to tree-local feature groups in \tilde{M}) is indicated by the expression |\tilde{M}|. Since Z is a subset of W, W is a subset of \tilde{M}, and neither Z nor W includes j, the inequality |Z|≤|W|<|\tilde{M}| holds.

In the outer sum, both [symbol] and Z are presented as iterator variables. Specifically, the first summation is computed across the possible values of [symbol] and, for each possible value of [symbol] , across the corresponding possible values of Z (recall that Z represents a subset of [symbol] ).

With respect to the functions α₁ and α₂, the Owen-like value h_{i∈Ŝ}_{ⱼ}(a) is a generalized formula for a class of coalitional game values that includes both Owen values and other types of game values. For other types of game values included in that class, the functions α₁ and α₂ may be different from each other. However, for Owen values, the symbols α₁ and α₂ both represent the same function—namely, the Shapley value weight function α.

The Shapley value weight function a (e.g., similar to the known weight value recited with respect to the generalized formula for computing Shapley values) receives two parameters as input. For example, as shown in the multiplicand of the outer sum above, the function a receives the expression |Z| (i.e., the cardinality of Z) as the first parameter and the expression |\tilde{M}|+|Z|−|W| as the second parameter. To evaluate the function α in this example, let the first parameter be represented by γ and let the second parameter be represented by θ. In terms of these letters, the function α(γ,θ) equals the value that results from evaluating the expression

$$\frac{γ ! ( θ - γ - 1 ) !}{θ !} .$$

Thus, in the multiplicand of the outer sum, α₁(|Z|, |\tilde{M}|+|Z|−|W|) equals the value that results when |Z| is inserted in the place of γ and |\tilde{M}|+|Z|−|W| is inserted in the place of θ in the expression for α(γ,θ).

Turning to the difference Δᵢ, Ŵ_{*} is a subset of the tree-local feature group Ŝⱼ. (Recall that the tree-local feature group Ŝⱼ includes group-local indices for the features used in the given tree and that the mapping I_{loc:glob} maps those group-local indices to respective global indices for those features.) Further, \hat{Z}_{*} is a subset of Ŵ_{*}. W_{*} represents the set of global indices to which the group-local indices included in Ŵ_{*} map in the mapping I_{loc:glob}. Similarly, Z_{*} represents the set of global indices to which the group-local indices included in \hat{Z}_{*}. map in the mapping I_{loc:glob}. |\hat{Z}_{*}| represents the cardinality of \hat{Z}_{*}, |Ŵ_{*}| represents the cardinality of Ŵ_{*}, and |Ŝⱼ| represents the cardinality of Ŝⱼ. These aspects of the iterator variables Ŵ_{*}, W_{*}, \hat{Z}_{*}, and Z_{*} are consistent across the minuend δ₁ and the subtrahend δ₂. However, the minuend δ₁ and the subtrahend δ₂ specify different types of relationships between the iterator variables Ŵ_{*}, W_{*}, \hat{Z}_{*}, and Z_{*} and the global index i (which corresponds to the global feature for which an Owen value is to be calculated), as explained below.

For the minuend δ₁, the expression i∈Z_{*} indicates that the global index i is included in Z_{*}, thereby indicating that the feature corresponding to the global index i is included in \hat{Z}_{*} (and in Ŵ_{*} and Ŝⱼ, since \hat{Z}_{*} is a subset of Ŵ_{*} and Ŵ_{*} is a subset of Ŝⱼ). (Recall that the feature i is considered to be included in the tree-local feature group Ŝⱼ if a group-local index included in the tree-local feature group Ŝⱼ maps to i in the mapping I_{loc:glob} for the given tree.)

By contrast, for the subtrahend δ₂, the expression i∉W_{*} indicates that the global index i is not included in W_{*}, thereby indicating that the feature corresponding to the global index i is not included in Ŵ_{*} (nor in \hat{Z}_{*}, since \hat{Z}_{*} is a subset of Ŵ_{*}).

As explained above, the function α₂ (like the function α₁ used in the multiplicand of the outer sum) refers to the Shapley value weight function that receives a first parameter and a second parameter as input. Thus, in the minuend, α₂(|\hat{Z}_{*}|−1, |Ŝⱼ|+|\hat{Z}_{*}|−|Ŵ_{*}|) equals the value that results when |Z_{*}|−1 is inserted in the place of γ and |Sⱼ|+|\hat{Z}_{*}|−|Ŵ_{*}| is inserted in the place of θ in the expression for α(γ,θ). Further, in the subtrahend, α₂(|\hat{Z}_{*}|, |Sⱼ|+Z_{*}|−|Ŵ_{*}|) equals the value that results when |\hat{Z}_{*}| is inserted in the place of γ and |Sⱼ|+|\hat{Z}_{*}|−|Ŵ_{*}| is inserted in the place of θ in the expression for α(γ,θ).

In the difference Δᵢ, both Ŵ_{*} and \hat{Z}_{*} are presented as iterator variables. Specifically, for the minuend, a summation with the general term α₂(|\hat{Z}_{*}|−1, |Ŝⱼ|+|\hat{Z}_{*}|−|Ŵ_{*}|) is computed across the possible values of Ŵ_{*} and, for each possible value of Ŵ_{*}, across the corresponding possible values of \hat{Z}_{*} (recall that \hat{Z}_{*} represents a subset of Ŵ_{*}). Similarly, for the subtrahend, a summation with the general term α₂(|\hat{Z}_{*}|, |Ŝⱼ|+|\hat{Z}_{*}|−|Ŵ_{*}|) is computed across the possible values of Ŵ_{*} and, for each possible value of Ŵ_{*}, across the corresponding possible values of \hat{Z}_{*}.

In addition, both the minuend δ₁ and the subtrahend δ₂ include a summation with the general term mp(b, −Z). In this context, the expression mp(b, −Z) represents the marginal path expectation (e.g., as explained with respect to the discussion for Shapley values above) for the path b and the set of features −Z. The path b is a path that is included in the preimage ε⁻¹(a,W) for the path a in accordance with the definition of preimages provided above in the discussion of Shapley values.

In both the minuend δ₁ and the subtrahend δ₂, Z represents a set of features that are represented by their corresponding tree-local indices (i.e., each element in Z is a tree-local index that corresponds to a respective feature that is included in Z). Z itself is included in a set of sets of features which will hereafter be called the intersection preimage. The intersection preimage for the tree-local group indicated by the tree-local index j is represented by the expression Int(Z, \hat{Z}_{*}, j, [symbol] ) and will be explained in greater detail in the following paragraphs. For both the minuend δ₁ and the subtrahend δ₂, respectively, Z_{*} represents the same set of features as Z (as noted above, though, recall that the relationship between Z_{*} and the global index i differs between the minuend δ₁ and the subtrahend δ₂). However, Z_{*} represents those features by their corresponding global indices instead of their corresponding tree-local indices (i.e., each element in Z_{*} is a global index that corresponds to a respective feature that is included in Z, although Z uses a tree-local index to represent the respective feature). Also note that −Z represents the complement of Z (i.e., features that are included in K that are not included in Z are included in −Z).

Like Z, W also represents a set of features that are represented by their corresponding tree-local indices (i.e., each element in W is a tree-local index that corresponds to a respective feature that is included in W) in both the minuend δ₁ and the subtrahend δ₂. The set W itself is included in a set of sets of features which will hereafter be called the inclusion preimage for the tree-local group indicated by the tree-local index j. The inclusion preimage is represented by the expression Inc( [symbol] ,W_{*},j, [symbol] ) and will be explained in greater detail in the following paragraphs. For both the minuend δ₁ and the subtrahend δ₂, respectively, W_{*} represents the same set of features as W (as noted above, though, recall that the relationship between W and the global index i differs between the minuend δ₁ and the subtrahend δ₂). However, W represents those features by their corresponding global indices instead of their corresponding tree-local indices (i.e., each element in W_{*} is a global index that corresponds to a respective feature that is included in W_{*}).

In terms of the difference Δᵢ, both Ŵ_{*} and \hat{Z}_{*} serve as iterator variables. Specifically, in the minuend δ₁, a summation with the general term α₂(|\hat{Z}_{*} |−1,|Ŝⱼ|+|\hat{Z}_{*}|−|Ŵ_{*}|) is computed across the possible values of Ŵ_{*} and, for each possible value of Ŵ_{*}, across the corresponding possible values of Z (recall that Z represents a subset of Ŵ_{*}). Similarly, in the subtrahend δ₂, a summation with the general term α₂(|\hat{Z}_{*}|, |Ŝⱼ|+|\hat{Z}_{*}|−|Ŵ_{*}|) is computed across the possible values of Ŵ_{*} and, for each possible value of Ŵ_{*}, across the corresponding possible values of \hat{Z}_{*}

Furthermore, in both minuend δ₁ and the subtrahend δ₂, respectively, b, Z, and W each serve as iterator variables. Specifically, both the minuend δ₁ and the subtrahend δ₂ include summations that are computed across each possible combination of the possible values of b, Z, and W.

As noted above, the inclusion preimage and the intersection preimage are represented by the expression Inc( [symbol] W_{*},j, [symbol] ) and the expression Int(Z,Z_{*},j, [symbol] ), respectively. The inclusion preimage and the intersection preimage refer to structures that the inventors created to allow Owen values to be determined with increased computational efficiency (e.g., by obviating multiple redundant computations that other approaches for determining Owen values would entail). The inclusion images represented by the expression Inc( [symbol] ,W_{*},j, [symbol] ) conform to the formal definition below:

$$Inc ( , {W}_{*} , j , 𝒫 ) := \{ Q \vert Q ⊆ K , Q ⋂ {\tilde{S}}_{j} = {W}_{*} , \{ r ∈ \tilde{M} ∖ \{ j \} \vert {\tilde{S}}_{r} ⊆ Q \} = \}$$

This formal definition establishes that the inclusion preimage for the tree-local group indicated by the tree-local index j includes each set Q of features that satisfies three conditions: (i) Q is a subset of K, where K indicates the set of features that are used in the given decision tree; (ii) the intersection set of Q and the set of local features \tilde{S}ⱼ equals the provided subset W_{*}; and (iii) the set of local indices other than j for local groups that are subsets of Q is equal to [symbol] .

In addition, the intersection preimage represented by the expression Int(Z,Z_{*},j, [symbol] ) conform to the formal definition below:

$$Int ( 𝒵 , {Z}_{*} , j , 𝒫 ) := \{ Q \vert Q ⊆ K , Q ⋂ {\tilde{S}}_{j} = {Z}_{*} , \{ r ∈ \tilde{M} ∖ \{ j \} \vert Q ⋂ {\tilde{S}}_{r} \neq ∅ \} = 𝒵 \}$$

This formal definition establishes that the intersection preimage for the tree-local group indicated by the tree-local index j includes each set Q of features that satisfies three conditions: (i) Q is a subset of K, where K indicates the set of features that are used in the given decision tree; (ii) the intersection set of Q and the set of local features S equals the provided subset \hat{Z}_{*}; and (iii) the set of local indices other than j for local groups whose respective intersection sets with Q are not empty is equal to Z.

Turning now to an explanation of how the various elements described above (e.g., the inclusion preimages, the intersection preimages, the path preimages, the marginal path expectations, the tree-local indices, the group-local indices, etc.) may be utilized in combination to compute Owen values with increased computational efficiency, it may be helpful to rewrite the formula provided above for determining the Owen value h_{i∈Ŝ}_{ⱼ}(a) (for every realizable leaf a and i∈Sⱼ) as follows:

$${h}_{i ∈ {\hat{S}}_{j}} ( a ) = {\sum }_{𝒵 ⊆ ⊆ \tilde{M}} {w}_{outer} [ \vert \vert , \vert 𝒵 \vert ; j ] \cdot {1}_{\{ j ∉ \}} \times [ \text{} \begin{matrix}\begin{matrix}{\sum }_{{\hat{Z}}_{*} ⊆ {\hat{W}}_{*} ⊆ {\hat{S}}_{j}} {w}_{inner +} [ {\hat{W}}_{*} , {\hat{Z}}_{*} ; j ] \cdot {1}_{i ∈ {Z}_{*}} {\sum }_{Z ∈ ( 𝒵 , {\hat{Z}}_{*} , j , 𝒫 ) , W ∈ ( , {\hat{W}}_{*} , j , 𝒫 )} \\ ( {\sum }_{b ∈ {ε}^{- 1} ( a , W )} mp ( b , Z ) )\end{matrix} \\ \begin{matrix}- {\sum }_{{\hat{Z}}_{*} ⊆ {\hat{W}}_{*} ⊆ {\hat{S}}_{j}} {w}_{inner -} [ {\hat{W}}_{*} , {\hat{Z}}_{*} ; j ] \cdot {1}_{i ∉ {W}_{*}} {\sum }_{Z ∈ ( 𝒵 , {\hat{Z}}_{*} , j , 𝒫 ) , W ∈ ( , {\hat{W}}_{*} , j , 𝒫 )} \\ ( {\sum }_{b ∈ {ε}^{- 1} ( a , W )} mp ( b , Z ) )\end{matrix}\end{matrix} ]$$

Rewriting the formula for determining Owen-like values in this manner facilitates the design of a fast implementation of this formula via a number of techniques which shall be presented below.

In this rewritten version of the formula for determining Owen-like values, several elements have been renamed and/or reformatted for illustrative purposes. For example, the inclusion preimage Inc( [symbol] ,W_{*},j, [symbol] ) has been replaced by the expression [symbol] ( [symbol] ,Ŵ_{*},j, [symbol] ). The tilde diacritic and the circumflex diacritic have been added to signify that the features indicated by the use of global indices in W_{*} are indicated by group-local indices in Ŵ_{*}. The set of sets of features represented by the inclusion preimage, though, is unchanged. Similarly, [symbol] (Z,\hat{Z}_{*},j, [symbol] ) replaces −Int(Z,Z_{*},j, [symbol] ), the complement of Int(Z,Z_{*},j, [symbol] ), to signify that the features indicated by the use of global indices in Z, are indicated by group-local indices in \hat{Z}_{*}. The set of sets of features represented by the intersection preimage, though, is unchanged.

In addition, the Shapley value weight α₁(|Z|, |\tilde{M}+|Z|−|W|) (recall that the function α₁ equals the function α in the case of Owen values, as described above) has been replaced by the expression wₒᵤₜₑᵣ[| [symbol] |, |Z|;j]·1_{{j∉W}} (the dependence on \tilde{M} omitted here because it is fixed in this case). These two expressions refer to the same quantity, but the expression that includes wₒᵤₜₑᵣ and the indicator function [symbol] presents the parameters more concisely and clarifies that this Shapley value weight is zero when [symbol] includes j (i.e., because the indicator function [symbol] equals one when [symbol] does not include j and zero otherwise.)

Similarly, the Shapley value weight α₂(|\hat{Z}_{*} |−1,|Ŝⱼ|+|\hat{Z}_{*}|−|Ŵ_{*}|) (recall that the function α₂ equals the function α in the case of Owen values, as described above) has been replaced by the expression wᵢₙₙₑᵣ₊[Ŵ_{*},\hat{Z}_{*};j]·1_{i∈Z}_{_{*}}. Again, these two expressions refer to the same quantity, but the expression that includes wᵢₙₙₑᵣ₊ and the indicator function 1_{i∈Z}_{_{*}} presents the parameters more concisely and clarifies that this Shapley value weight is zero when Z_{*} does not include i (i.e., because the indicator function 1_{i∈Z}_{_{*}} equals one when Z_{*} includes i and zero otherwise.)

Similarly, the Shapley value weight α₂(|\hat{Z}_{*}|, |Ŝⱼ|+|\hat{Z}_{*}|−|Ŵ_{*}|) (again recall that the function α₂ equals the function α in the case of Owen values, as described above) has been replaced by the expression wᵢₙₙₑᵣ₋[Ŵ_{*},\hat{Z}_{*};j]·1_{i∉W}_{_{*}}. Again, these two expressions refer to the same quantity, but the expression that includes wᵢₙₙₑᵣ₋ and the indicator function 1_{i∉W}_{_{*}} presents the parameters more concisely and clarifies that this Shapley value weight is zero when W includes i (i.e., because the indicator function 1_{i∉W}_{_{*}} equals one when W_{*} does not include j and zero otherwise.)

Turning now to computationally efficient approaches for determining Owen values, rewritten version of the formula for determining Owen-like values allows computations that would be performed redundantly in the naïve implementation to be performed just once such that the results can be stored and retrieved for use during subsequent computations rather than recomputed for use during those subsequent computations. Approaches for determining Owen values may leverage this unexpected advantageous property to increase computational efficiency.

One such an approach for determining Owen values with increased computational efficiency may commence by performing a number of preliminary computations (i.e., precomputations) beforehand and storing the results of these computations in a data structure for later retrieval when Owen values are in the process of being determined. For a given decision tree, the path preimages ε⁻¹(a,W) are computed for each leaf a and each possible subset W of the features indicated by the tree-local indices for the features K used in the given tree. The path preimages ε⁻¹(a,W) may be stored, for example, as a matrix in any type of data structure that is suitable for storing matrices.

Furthermore, the marginal path expectations mp(a,W) are computed for each leaf a and each possible subset W of the features indicated by the tree-local indices for the features K used in the given tree. The marginal path expectations mp(a,W) may be stored, for example, as a matrix in any type of data structure that is suitable for storing matrices.

Further still, the Shapley value weights indicated by wₒᵤₜₑᵣ, wᵢₙₙₑᵣ₊, and wᵢₙₙₑᵣ₋ are precomputed for each tree-local feature group j represented by the tree-local indices in M. The Shapley value weights indicated by wₒᵤₜₑᵣ may be stored as a matrix of size K×K in any data structure suitable for storing matrices. For each tree-local group j, the Shapley value weights indicated by wᵢₙₙₑᵣ₊ may be stored as a matrix of size |\tilde{S}ⱼ|×|\tilde{S}ⱼ|. Similarly, for each tree-local group j, the Shapley value weights indicated by wᵢₙₙₑᵣ₋ may also be stored as a matrix of size |\tilde{S}ⱼ|×|\tilde{S}ⱼ|.

Further still, a set of possible pairs of the possible values of Z and W is computed. (Recall that Z is a subset of W and W is a subset of \tilde{M}.) In addition, for each possible value of j, a set of possible pairs of the possible values of \hat{Z}_{*} and Ŵ_{*} is computed. (Recall that \hat{Z}_{*} is a subset of Ŵ_{*} and Ŵ_{*} is a subset of Ŝⱼ.) Persons of skill in the art will recognize that sets of possible pairs may be stored in many different types of data structures.

Further still, the intersection preimages and the inclusion preimages are computed for each tree-local feature group j represented by the tree-local indices in \tilde{M}. The intersection preimage for a single tree-local feature group is, in and of itself, a set of sets of features. Therefore, the intersection images for multiple tree-local feature groups collectively constitute a set of sets of sets. Similarly, the inclusion preimages for multiple tree-local feature groups collectively constitute a set of sets of sets. Persons of skill in the art will recognize that sets of sets of sets may be stored in many different types of data structures (e.g., lists of lists of lists in Python, arrays (or hashes) of arrays (or hashes) of arrays (or hashes) in Perl, etc.).

Once the preliminary computations listed above are complete, the Owen values for the features used by a given decision tree can be computed for each leaf in the given decision tree via a number of nested loops as explained below. Note that the nested loops implement an approach in which iterating through the possible values of (i) the leaf a and (ii) the feature i is performed within a fourth loop that is nested within three loops that iterate over other types of values. By contrast, a naïve implementation of the rewritten version of the formula for determining Owen-like values described above would involve iterating through the possible values of the leaf a and the possible values of the feature i in loops that are not nested as deeply, such that many redundant calculations would be made. By iterating through the possible values of the leaf a and the possible values of the feature i within the fourth loop in conjunction with utilizing the results of the precomputations, this approach helps to achieve greater computational efficiency than the naïve implementation because redundant calculations involved in the naïve implementation are avoided.

In this approach, a vector of respective tree-local Owen values for the features used in the given decision tree for each leaf in the given decision tree may be initialized with each respective tree-local Owen value initially set to zero. Next, a first loop may be configured to iterate over each possible value of W (recall that W represents a subset of the set of tree-local indices M of the tree-local feature groups for the given tree, where each tree-local index represents the respective tree-local feature group to which it corresponds in the local partition [symbol] ={Ŝ₁, Ŝ₂, . . . , Ŝ_{\tilde{m}}}).

A second loop may be nested within the first loop and may be configured to iterate over each possible value of Z (recall that Z represents a subset of W).

A third loop may be nested within the second loop and may be configured to iterate over each possible value of j that is not included in W (recall that j represents a tree-local index of a tree-local feature group).

A fourth loop may be nested within the third loop and may be configured to iterate over each possible value of Ŵ_{*} (recall that Ŵ_{*} is a subset of the tree-local feature group Ŝⱼ, where group-local indices are used to refer to features). Within the fourth loop, the inclusion preimage for the current values of [symbol] , Ŵ_{*}, and j (i.e., the preimage [symbol] ( [symbol] ,Ŵ_{*},j, [symbol] )) may be retrieved from a data structure in which the inclusion preimages were stored during the preliminary computations. The retrieved inclusion preimage may be stored in the form of a variable that is defined at least within the scope of the fourth loop.

A fifth loop may be nested within the fourth loop and may be configured to iterate over each possible value of \hat{Z}_{*} (recall that \hat{Z}_{*} is a subset of Ŵ_{*}). Within the fifth loop, the intersection preimage for the current values of Z, \hat{Z}_{*}, and j (i.e., the preimage [symbol] (Z,\hat{Z}_{*};j, [symbol] )) may be retrieved from a data structure in which the intersection preimages were stored during the preliminary computations. The retrieved intersection preimage may be stored in the form of a variable that is defined at least within the scope of the fourth loop.

Returning to the fourth loop, the Shapley value weight wₒᵤₜₑᵣ for the current value of [symbol] and the current value of Z may be retrieved from a data structure in which the wₒᵤₜₑᵣ Shapley [symbol] value weights were stored during the preliminary computations. The retrieved Shapley value weight wₒᵤₜₑᵣ may be stored in the form of a variable that is defined at least within the scope of the fourth loop. In addition, the Shapley value weight wᵢₙₙₑᵣ₊ for the current values of Ŵ_{*}, \hat{Z}_{*}, and j may be retrieved from a data structure in which the wᵢₙₙₑᵣ₊ Shapley value weights were stored during the preliminary computations. The retrieved Shapley value weight wᵢₙₙₑᵣ₊ may be stored in the form of a variable that is defined at least within the scope of the fourth loop. Furthermore, the Shapley value weight wᵢₙₙₑᵣ₋ for the current values of Ŵ_{*}, \hat{Z}_{*}, and j may be retrieved from a data structure in which the wᵢₙₙₑᵣ₋ Shapley value weights were stored during the preliminary computations. The retrieved Shapley value weight wᵢₙₙₑᵣ₋ may be stored in the form of a variable that is defined at least within the scope of the fourth loop.

Furthermore, within the fourth loop, a plurality of vectors in the matrix of marginal path expectations that correspond to the inclusion preimage for the current values of Z and Z, are added together to form an intermediate vector. The intermediate vector may be stored in the form of a variable that is defined at least within the scope of the fourth loop. In addition, a sum-tracker vector configured to store sums of values in the intermediate vector that correspond to possible values of W may be initialized with each sum to be stored therein as zero. The sum-tracker vector may be in scope at least throughout the fourth loop.

To illustrate how the intermediate vector relates to the rewritten version of the formula for determining Owen-like values described above, let the following triple sum that appears in the rewritten version be represented by [symbol] as shown below:

$${\sum }_{Z ∈ ( 𝒵 , {\hat{Z}}_{*} , j , 𝒫 )} {\sum }_{W ∈ ( , {\hat{W}}_{*} , j , 𝒫 )} ( {\sum }_{b ∈ {ε}^{- 1} ( a , W )} mp ( b , Z ) ) = ( a ; 𝒵 , {\hat{Z}}_{*} , , {\hat{W}}_{*} , j )$$

Furthermore, let the intermediate vector be represented by v as shown below:

$$v ( \cdot ; 𝒵 , {\hat{Z}}_{*} , j , 𝒫 ) = {\sum }_{Z ∈ ( 𝒵 , {\hat{Z}}_{*} , j , 𝒫 )} mp ( \cdot ; Z )$$

In the expression v(⋅;Z,\hat{Z}_{*},j, [symbol] ), “⋅” represents a placeholder for a leaf and Z and \hat{Z}_{*} represent the current values of Z and \hat{Z}_{*}, respectively. Each entry in the intermediate vector v(⋅;Z,\hat{Z}_{*},j, [symbol] ) corresponds to a respective leaf in the given tree. The intermediate vector v(⋅;Z,\hat{Z}_{*},j, [symbol] ) can be used to evaluate the triple sum [symbol] (a;Z,\hat{Z}_{*}, [symbol] ,Ŵ_{*},j) with increased efficiency if the triple sum is rewritten as shown below:

$$( a ; 𝒵 , {\hat{Z}}_{*} , , {\hat{W}}_{*} , j ) = {\sum }_{W ∈ ( , {\hat{W}}_{*} , j , 𝒫 )} ( {\sum }_{b ∈ {ε}^{- 1} ( a , W )} v ( b ; 𝒵 , {\hat{Z}}_{*} , j , 𝒫 ) )$$

Utilizing the intermediate vector v to evaluate the triple sum (e.g., within the sixth loop, as described below) obviates the recalculation of identical sums that would occur in a naïve implementation.

A sixth loop may be nested within the fourth loop and may be configured to iterate through each possible value of W (recall that represents a set of features that are re resented by their corresponding tree-local indices) that is included in the inclusion preimage [symbol] ( [symbol] ,Ŵ_{*},j, [symbol] ) (recall that the inclusion preimage is a set of sets of features). Within the sixth loop, the path preimages ε⁻¹(a,W) for each leaf a in the given tree for the current value of W may be retrieved from a data structure in which the path preimages were stored during the preliminary computations. The retrieved path preimages may be stored in the form of a variable that is defined at least within the scope of the sixth loop. Furthermore, the sum of elements in the intermediate vector that correspond to the retrieved path preimages for the current value of W may be added to the sum corresponding to the current value of W in the sum-tracker vector. The entries (e.g., sums) in the sum-tracker vector are complete when the sixth loop has completed iterating through the possible values of W that are included in the inclusion preimage [symbol] ( [symbol] ,Ŵ_{*},j, [symbol] ). Each entry in the sum-tracker vector corresponds to a respective leaf in the given tree. Specifically, the sum-tracker vector is the vector of triple sums [symbol] (⋅;Z,\hat{Z}_{*}, [symbol] ,Ŵ_{*},j), where ⋅ is a placeholder for a leaf value.

Returning to the fourth loop, a first condition specifying that the feature represented by the global feature index i for the current feature (i.e., the feature for which an Owen value is currently being determined) is included in \hat{Z}_{*} may be evaluated. If the first condition is satisfied, each tree-local Owen value for the current feature for each realizable leaf may be increased by an amount equal to the corresponding sum for the realizable leaf in the sum-tracker vector multiplied by the wᵢₙₙₑᵣ₊ for the current values of Ŵ_{*}, \hat{Z}_{*}, and j. Furthermore, a second condition specifying that the feature represented by the global feature index i for the current feature is included in the complement of Ŵ_{*} may be evaluated. If the second condition is satisfied, each tree-local Owen value for the current feature for the realizable leaf may be increased by an amount equal to the corresponding sum for the realizable leaf in the sum-tracker vector multiplied by the wᵢₙₙₑᵣ₊ for the current values of Ŵ_{*}, \hat{Z}_{*}, and j. The respective tree-local Owen values may be stored in the vector of respective tree-local Owen values mentioned above.

The respective operations (e.g., increasing one or more tree-local Owen values) that are performed in response to determining the first condition and/or the second condition are satisfied allow the respective tree-local Owen values for a feature to be updated for multiple leaves during a single iteration of the fourth loop. This increases computational efficiency because the actions of determining whether first and second conditions are satisfied and executing the blocks of programming code that are contingent on the first and second conditions do not have to be repeated for each of the features.

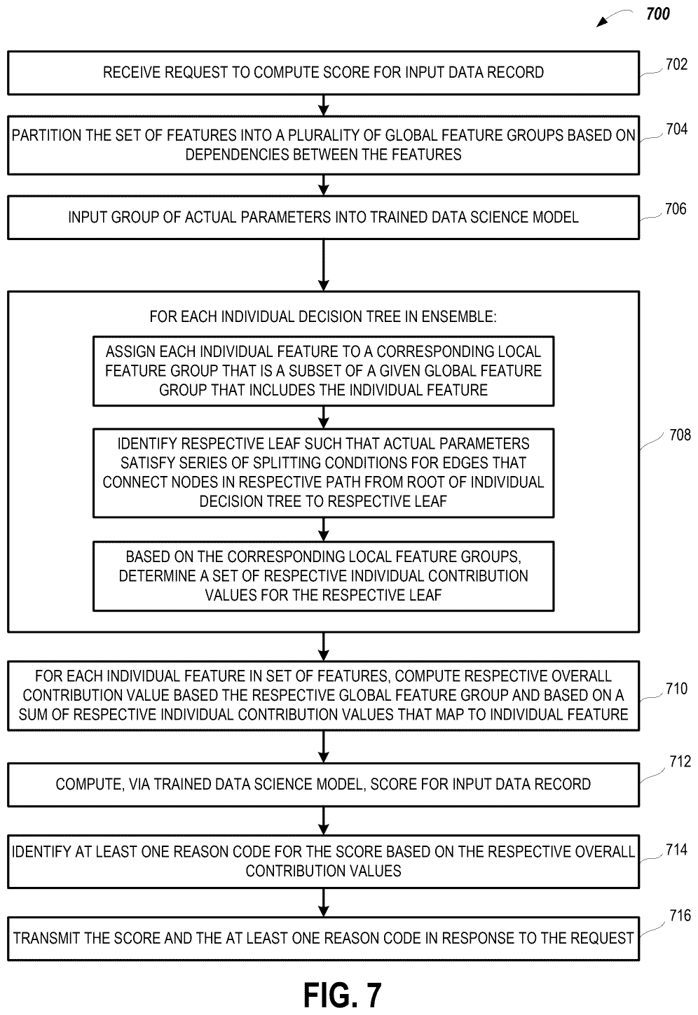

Turning to FIG. 7, a flow chart is shown that illustrates one example of a process 700 for determining contribution values for features used in a data science model comprising one or more decision trees in accordance with the present disclosure. The example process 700 of FIG. 7 may be carried out by any computing platform that is capable of creating a data science model, including but not limited to the computing platform 102 of FIG. 1. Further, it should be understood that the example process 700 of FIG. 7 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

Prior to commencement of the example process 700, a model object for a data science model that is to be deployed by an entity for use in making a particular type of decision may be trained. In general, this model object may comprise any model object that is configured to (i) receive an input data record comprising a set of actual parameters that are related to a respective individual (e.g., person) and map to a particular set of formal parameters (which may also be referred to as the model object's “features” or the model object's “predictors”), (ii) evaluate the received input data record, and (iii) based on the evaluation, output a score that is then used make the given type of decision with respect to the respective individual. Further, the model object that is trained may take any of various forms, which may depend on the particular data science model that is to be deployed.

For instance, as one possibility, the model object may comprise a model object for a data science model to be utilized by an entity to decide whether or not to extend a particular type of service (e.g., a loan, a credit card account, a bank account, or the like) to a respective individual within a population. In this respect, the set of formal parameters for the model object may comprise data variables that are predictive of whether or not the entity should extend the particular type of service to a respective individual (e.g., variables that provide information related to credit score, credit history, loan history, work history, income, debt, assets, etc.), and the score may indicate a likelihood that the entity should extend the particular type of service to the respective individual, which may then be compared to a threshold value in order to reach a decision of whether or not to extend the particular type of service to the respective individual.

The function of training the model object may also take any of various forms, and in at least some implementations, may involve applying a machine-learning process to a training dataset that is relevant to the particular type of decision to be rendered by the data science model (e.g., a set of historical data records for individuals that are each labeled with an indicator of whether or not a favorable decision should be rendered based on the historical data record). In this respect, the machine-learning process may comprise any of various machine learning techniques, examples of which may include decision-tree techniques, among various other possibilities.

As shown in FIG. 7, the example process 700 may begin at block 702 upon receiving a request to compute a score for an input data record. The input data record may comprise a group of actual parameters that map to a set of features that a trained data science model (e.g., the model object) is configured to receive as input.

As shown in block 704, the example process 700 further includes partitioning the set of features into a plurality of global feature groups based on dependencies between the features.

The features may be partitioned into two or more global feature groups based on dependencies (e.g., based on the mutual information shared between the features), where each global feature group comprises at least one feature. In this respect, any technique now known or later developed to partition the features into groups may be used based on such dependencies, including, but not limited to, any of various possible clustering techniques.

For instance, as one possibility, the features may be partitioned into global feature groups utilizing a clustering technique that is based on Maximal Information Coefficient (MIC) values, which are a regularized (e.g., normalized) version of mutual information that provide measures of the dependency strengths between different pairs of features. For example, an MIC value for a pair of features that is near or at 0 indicates that there is little or no dependency between the features in the pair (e.g., the features in the pair are independent of one another), whereas an MIC value for a pair of features that is at or near 1 indicates that there is a strong dependency between the features in the pair (e.g., the features are dependent on one another).

In order to cluster based on these MIC values, a computing platform may begin by determining a respective MIC value for each possible pair of features based on an analysis of a training dataset (e.g., the training dataset that was used to train the date science model). Next, the computing platform may (i) translate the MIC values into dissimilarity values (e.g., by taking the respective complements of the MIC values, where the respective complement of a given MIC value may be determined by subtracting the given MIC value from one) and then (ii) input those dissimilarity values into an agglomerative clustering algorithm that functions to cluster the features in a “bottom up” manner by initially treating each feature as a single-feature cluster, and then during each iteration of the algorithm, merging a selected pair of clusters (e.g., the pair of clusters having the a smallest intergroup dissimilarity) into a combined cluster. Such an algorithm may continue to iterate until all of the features have been merged into one combined cluster, and the result is a dendrogram (also referred to as a partition tree) that encodes the strength of the dependencies between the features in terms of hierarchal tree of clusters, where the height of the line that connects two lower-level clusters represents the dissimilarly between the lower-level clusters. After the dendrogram has been produced, the computing platform may apply a threshold dissimilarity value to the dendrogram in order to cut the tree at a given height and thereby define a particular set of feature clusters that satisfy the threshold dissimilarity value, which may then be utilized as the global feature groups that are defined based on dependencies.

As another possibility, the computing platform may group the model object's features together utilizing a clustering technique that is based on principal component analysis (PCA) (e.g., the PROC VARCLUS clustering technique developed by SAS®). According to one such PCA-based clustering technique, the computing platform may begin by assigning each of the model object's features to a single cluster, generating a covariance matrix for the model object's features based on an analysis of a training dataset (e.g., the training dataset that was used to train model object), and then utilizing the generated covariance matrix to split the single cluster of features into two clusters of features. The computing platform may then iteratively repeat this process in a “top down” manner for each resulting cluster until all clusters include only a single feature, which forms a tree structure representing the relationships between the features. In turn, the computing platform may then combine clusters of features within the tree structure together into a group if the correlation between the features in the clusters is above a threshold. However, it should be understood that this is just one possible example of a PCA-based clustering technique, and that other PCA-based clustering techniques could also be utilized to group the model object's features together based on dependencies.

The computing platform could also utilize other clustering techniques to group the model object's features together based on their dependencies.

Further details regarding these and other techniques for grouping a model object's features together based on dependencies can be found in (i) U.S. patent application Ser. No. 16/868,019, which was filed on May 6, 2020 and is entitled “SYSTEM AND METHOD FOR UTILIZING GROUPED PARTIAL DEPENDENCE PLOTS AND SHAPLEY ADDITIVE EXPLANATIONS IN THE GENERATION OF ADVERSE ACTION REASON CODES,” and (ii) U.S. patent application Ser. No. 17/322,828, which was filed on May 17, 2021 and is entitled “SYSTEM AND METHOD FOR UTILIZING GROUPED PARTIAL DEPENDENCE PLOTS AND GAME-THEORETIC CONCEPTS AND THEIR EXTENSIONS IN THE GENERATION OF ADVERSE ACTION REASON CODES,” each of which is incorporated herein by reference in its entirety, and (iii) the paper entitled “Stability theory of game-theoretic group feature explanations for machine learning models” by Miroshnikov et al. (2024), which can be found at https://arxiv.org/abs/2102.10878v5 and is incorporated herein by reference in its entirety.

As shown in block 706, the example process 700 further includes inputting the group of actual parameters into the trained data science model. The trained data science model comprises an ensemble of decision trees wherein each individual decision tree in the ensemble is symmetric, each individual decision tree in the ensemble is configured to receive a respective subset of the features as input, and, within each individual decision tree, internal nodes that are positioned in a same level designate a same splitting criterion based on a same feature selected from the respective subset of features. The trained data science model may be, for example, a CatBoost model.

As shown in block 708, the example process 700 further includes, for each individual decision tree in the ensemble, (i) assigning each individual feature in the subset of features for the individual decision tree to a corresponding local feature group that is a subset of a given global feature group that includes the individual feature, (ii) identifying a respective leaf such that the actual parameters satisfy a series of splitting conditions for edges that connect nodes in a respective path from a root of the individual decision tree to the respective leaf, and (iii) based on the corresponding local feature groups, determining a set of respective individual contribution values for the respective leaf based on the corresponding local feature groups. Each of the respective individual contribution values maps to a respective feature found in the respective subset of features of the individual decision tree. The respective individual contribution values and the respective overall contribution values may be, for example, Owen values or Banzhaf-Owen values.

As shown in block 710, the example process 700 further includes, for each individual feature in the set of features, computing a respective overall contribution value based the respective global feature group and based on a sum of the respective individual contribution values that map to that individual feature. This may be achieved, for example, by summing the local contribution values for the individual feature across the trees in the ensemble.

As shown in block 712, the example process 700 further includes computing, via the trained data science model, the score for the input data record. For example, the input data record score for the first input data record may be determined based on respective labels (e.g., scores) associated with the leaves in the ensemble into which the input data record falls.

Further, as shown in block 714, the example process may further include identifying at least one reason code for the score based on the respective overall contribution values for the individual features in the set of features.

Still further, as shown in block 716, the example process 700 may include transmitting the score and the at least one reason code in response to the request.

FIGS. 8A-F are a series of diagrams that serve to illustrate how example values may be assigned to symbols described herein, according to one simplified example of determining Owen values based on the discussion above. Persons of skill in the art will recognize that the number of features used by an ensemble of decision trees, the number of features used by a given decision tree, the number of groups in a global partition for an ensemble, the number of groups in a local partition for a given decision tree, the number of features in a feature group, and the other quantities discussed below with respect to FIGS. 8A-F may be significantly larger in practice. FIGS. 8A-F are provided for illustrative purposes to help readers visualize how elements described herein may operate in the context of a working example.

Turning to FIG. 8A, in this example, let an ensemble of decision trees be configured to receive twelve global features (depicted by the vector X) as input, as shown in the selection 801. Furthermore, to facilitate efficient computation for the further operations discussed above, let the global features be represented by their respective indices in the vector X (depicted by the set N of global feature indices), as shown in the selection 802. In this example, further let the global features be partitioned into four global feature groups (depicted by S₁, S₂, S₃, S₄), as shown in the selection 803. Similar to the global features, let the global feature groups be represented by their respective global feature indices (depicted by the set M), as shown in the selection 804. With the global features and global feature groups thus defined in the context of this example, the global partition (depicted by P) of global features into global feature groups can be transcribed in the forms shown in the selection 805.

Turning to FIG. 8B, let a given decision tree within the ensemble described with respect to FIG. 8A be configured to receive a subset of the global features as input. Specifically, in this example, let the given decision tree be configured to receive the global features X₂, X₄, X₅, X₈, X₉, X₁₀ as input. Furthermore, to facilitate efficient computation for the further operations discussed below, let the global features X₂, X₄, X₅, X₈, X₉, X₁₀ be represented in the form of corresponding tree-local features \tilde{X}₁, \tilde{X}₂, \tilde{X}₃, \tilde{X}₄, X₅, \tilde{X}₆, respectively, as shown in the selection 810. To facilitate rapid translation of tree-local features to global features, let a mapping (depicted by [symbol] _{:glob}) be defined as shown in the selection 811. The mapping may be stored, for example, [symbol] as an array (e.g., as shown in the selection 811) such that a position of a given value stored the array specifies a tree-local feature index, while the given value at the position specifies a corresponding global feature index. For instance, as shown in the selection 811, the value “2” at the first position in the array indicates that a tree-local feature index of one maps to a global feature index of two. Similarly, the value “4” at the second position in the array indicates a tree-local feature index of two maps to a global feature index of four. This pattern holds for the other values shown in the array.

Collectively, as shown in the selection 812, the tree-local features \tilde{X}₁, \tilde{X}₂, \tilde{X}₃, \tilde{X}₄, \tilde{X}₅, \tilde{X}₆ may be depicted by the vector \tilde{X}. However, to further facilitate efficient computation for the operations discussed below, let the tree-local feature groups be represented by their respective local feature indices (depicted by the set K), as shown in the selection 813.

Turning again to the global feature groups S₁, S₂, S₃, S₄ in the partition P, note that some of the global feature groups include global features that the given decision tree is not configured to receive as input. In the selection 814, the global feature indices of the global features that the given decision tree is not configured to receive as input are shown in strikethrough. To facilitate efficiency, the global feature indices of these unused global features may be excluded from further analysis for the purpose of determining Owen values in the context of the given tree, thereby forming subsets of the global feature groups (e.g., as shown in the selection 814). Furthermore, to further facilitate efficient computation for the operations discussed below, the global feature indices included in the subsets of the global feature groups may be converted (e.g., via the mapping depicted by [symbol] _{:glob}) to their corresponding tree-local feature indices. The tree-local feature groups shown in the selection 815 are the subsets of the global feature groups \tilde{S}₁, \tilde{S}₂, \tilde{S}₃, \tilde{S}₄ shown in the selection 814 after the global feature indices have been converted to their corresponding tree-local indices.

Turning to FIG. 8C, let the tree-local feature groups be represented by their respective tree-local feature indices (depicted by the set \tilde{M}), as shown in selection 820. With the tree-local features and tree-local feature groups thus defined in the context of this example, the tree-local partition (depicted by [symbol] ) of tree-local features into tree-local feature groups can be transcribed in the forms shown in the selection 821.

To facilitate rapid translation of tree-local feature groups to global feature groups, let a mapping (depicted by I [symbol] _{:glob}) be defined as shown in the selection 822. The mapping may be stored, for example, as an array (e.g., as shown in the selection 822) such that a position of a given value stored the array specifies a tree-local group index, while the given value at the position specifies a corresponding global group index. For instance, as shown in the selection 822, the value “1” at the first position in the array indicates that a tree-local group index of one maps to a global group index of one. Similarly, the value “2” at the second position in the array indicates a tree-local group index of two maps to a global group index of two. This pattern holds for the other values shown in the array. Note that, although the tree-local group indices in this example match their corresponding global group indices, tree-local group indices and global group indices might not match each other in other examples (e.g., examples in which a given decision tree in the ensemble does not include at least one global feature from a global feature group, such that the global feature group is not represented in the given decision tree).

In addition, to further facilitate efficient computation for the operations discussed below, let the tree-local features in each given tree-local feature group be represented in the form of corresponding group-local features that are local to the given tree-local feature group. For instance, as shown in the selection 823, let the tree-local feature \tilde{X}₁ included in the tree-local feature group \tilde{S}₁ be depicted by the group-local feature \tilde{X}₁. Similarly, as shown in the selection 824, let the tree-local feature \tilde{X}₂ and the tree-local feature \tilde{X}₃ included in the tree-local feature group \tilde{S}₂ be depicted by the group-local features \tilde{X}₁, \tilde{X}₂. In addition, as shown in the selection 825, let the tree-local feature \tilde{X}₄ and the tree-local feature \tilde{X}₅ included in the tree-local feature group \tilde{S}₃ be depicted by the group-local features \hat{X}₁, \hat{X}\tilde{X}₂. Also, as shown in the selection 826, let the tree-local feature \tilde{X}₆ included in the tree-local feature group \tilde{S}₄ be depicted by the group-local feature \hat{X}₁.

Turning to FIG. 8D, further let the group-local features for each tree-local group be represented by their respective group-local feature indices (depicted by the set \hat{K}). For instance, the set \hat{K} shown in the selection 830 represents the feature included in the tree-local feature group \tilde{S}₁ via the feature's group-local feature index. Similarly, the set \hat{K} shown in the selection 831 represents the features included in the tree-local feature group \tilde{S}₂ via the features' respective group-local feature indices. In addition, the set \hat{K} shown in the selection 832 represents the features included in the tree-local feature group \tilde{S}₃ via the features' respective group-local feature indices. Also, the set \hat{K} shown in the selection 833 represents the feature included in the tree-local feature group \tilde{S}₄ via the feature's group-local feature index. Since features not used in the given decision tree were excluded from the tree-local feature groups and the tree-local feature groups have not been partitioned into subgroups, each of the tree-local feature groups Ŝ₁, Ŝ₂, Ŝ₃, Ŝ₄ matches the respective set K for that feature group (e.g., as can be seen by comparing the selections 834, 835, 836, 837 to the selections 830, 831, 832, 833, respectively). Note that the circumflex diacritic mark indicates that group-local feature indices are used to represent the features included in the tree-local groups Ŝ₁, Ŝ₂, Ŝ₃, Ŝ₄ (although the tree-local group indices are still used as the subscripts for these groups). With the group-local features thus defined in the context of this example, the tree-local partition (depicted by [symbol] ) can be transcribed in the forms shown in the selection 838.

With the notations for the global feature indices, the global group indices, the tree-local feature indices, the tree-local group indices, and the group-local feature indices for this example explained above FIGS. 8A-C, it will now be illustrative to describe how values of some of the symbols used in the formula h_{i∈Ŝ}_{ⱼ}(a) above would be determined for a particular feature of interest i, which is a member of a group of interest j, for the leaf a. For instance, in the following example depicted in FIGS. 8E-F, let the feature of interest i for which an Owen value is to be determined be the global feature X₄, which is a member of the global group S₂ and of the tree-local group \tilde{S}₂. In practice, similar precomputations would generally be made for each feature in each group. FIGS. 8E-F are provided merely for illustrative purposes to clarify how certain methods described above could be applied.

Turning to FIG. 8E, the possible values of W and Z for this example when the tree-local feature group index j (e.g., in the context of the formula h_{i∈Ŝ}_{ⱼ}(a) shown further above for determining Owen values) is assigned the value of two are shown. The selection 840 depicts the set of tree-local group indices in the set \tilde{M}\{2} (which is the set of tree-local group indices that would remain in \tilde{M} if the index of two were to be removed). As shown in the selections 841a-g, there are seven possible non-empty subsets of the set \tilde{M}\{2}. Each of these possible non-empty subsets is a possible value of W. The selections 842a-s further show the respective possible non-empty subsets for each possible value of [symbol] . The possible subsets for each given value of [symbol] are the possible values of Z for the given [symbol] .

Turning to FIG. 8F, the possible values of Ŵ_{*} and \hat{Z}_{*} for this example when the tree-local feature group index j (e.g., in the context of the formula h_{i∈Ŝ}_{ⱼ}(a) shown further above for determining Owen values) is assigned the value of two are shown. As shown in the selection 850, the tree-local feature group Ŝ₂ is represented as the set {1,2} (where group-local feature indices are used to depict the features).

The selections 851a-c depict the possible subsets of Ŝ₂ using the group-local feature indices specific to the group Ŝ₂. The selections 852a-c depict the possible subsets of Ŝ₂ after group-local feature indices have been converted to tree-local feature indices. The selections 853a-c depict the possible subsets of Ŝ₂ after tree-local feature indices have been converted to global feature indices. With the feature indices this converted, the possible subsets are the possible values of Ŵ_{*}. The selections 854a-e depict the possible subsets of each respective value of Ŵ_{*} (which are the possible values of \hat{Z}_{*}).

Note that the example above represents precomputation that can be advantageously performed before any input data record is evaluated. This, in turn, provides for the efficient evaluation of Owen values for each feature across each leaf in each tree of a model. Similar to the manner described above with regard to Shapley values, Owen values can be computed on a leaf-by-leaf basis rather than on an input-data-record-by-input-data-record basis. In particular, the formula for h_{i∈Ŝ}_{ⱼ}(a) can be evaluated for each group j and each feature i for each leaf of each decision tree in an ensemble before any input data records are received for analysis—and even before the ensemble is deployed for use. If the Owen values are precomputed on a leaf-by-leaf basis beforehand and stored for rapid retrieval in a data structure, the Owen values for each given global feature across the ensemble for a classification decision rendered by the ensemble for an input data record can be computed by retrieving and summing the Owen values for the given feature across the leaves into which the input data record lands in the ensemble.

Many advantages result from applying the techniques, structures, and systems described above for computing Owen values. For instance, certain structures described herein (e.g., path preimages, intersection preimages, and inclusion preimages) serve as new data structures that, when applied as described herein, facilitate increased computational efficiency that cannot be achieved by previous methods for determining Owen values. This increased computational efficiency allows Owen values to be computed rapidly enough for practical use in industry applications, where an explanation of a model's classification decision is needed with very little delay. By contrast, the inefficiency of previous approaches for determining Owen values would result in unacceptable levels of lag time for even large cloud computing systems, thereby rendering such approaches impractical for industry use for ensembles that have acceptable levels of classification accuracy (e.g., because ensembles that achieve sufficient levels of classification accuracy typically use hundreds or even thousands of trees and many input features). In addition, the techniques, structures, and systems described herein allow the computational load for determining Owen values to be distributed over a period time before deployment of the ensemble. Distribution of the computational load of determining Owen values over such a period of time before deployment is not possible with previous methods for determining Owen values. Thus, the techniques, structures, and systems described herein both reduce the computational load and facilitate distribution of the computational load over a time period that is unavailable for computation under previous approaches.

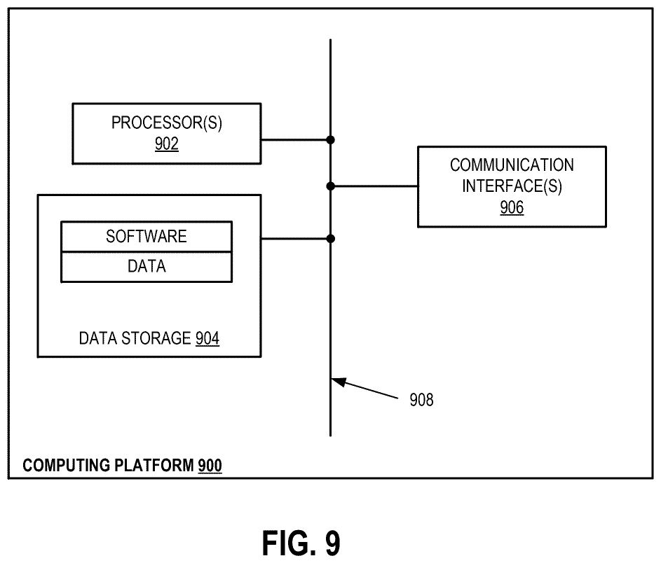

Turning now to FIG. 9, a simplified block diagram is provided to illustrate some structural components that may be included in an example computing platform 900 that may be configured to perform some or all of the functions discussed herein for creating a data science model in accordance with the present disclosure. At a high level, computing platform 900 may generally comprise any one or more computer systems (e.g., one or more servers) that collectively include one or more processors 902, data storage 904, and one or more communication interfaces 906, all of which may be communicatively linked by a communication link 908 that may take the form of a system bus, a communication network such as a public, private, or hybrid cloud, or some other connection mechanism. Each of these components may take various forms.

For instance, the one or more processors 902 may comprise one or more processor components, such as one or more central processing units (CPUs), graphics processing units (GPUs), application-specific integrated circuits (ASICs), digital signal processor (DSPs), and/or programmable logic devices such as a field programmable gate arrays (FPGAs), among other possible types of processing components. In line with the discussion above, it should also be understood that the one or more processors 902 could comprise processing components that are distributed across a plurality of physical computing devices connected via a network, such as a computing cluster of a public, private, or hybrid cloud.

In turn, data storage 904 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 904 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 9, data storage 904 may be capable of storing both (i) program instructions that are executable by processor 902 such that the computing platform 900 is configured to perform any of the various functions disclosed herein (including but not limited to any the functions described above with reference to FIGS. 3A-3B), and (ii) data that may be received, derived, or otherwise stored by computing platform 900.

The one or more communication interfaces 906 may comprise one or more interfaces that facilitate communication between computing platform 900 and other systems or devices, where each such interface may be wired and/or wireless and may communicate according to any of various communication protocols, examples of which may include Ethernet, Wi-Fi, serial bus (e.g., Universal Serial Bus (USB) or Firewire), cellular network, and/or short-range wireless protocols, among other possibilities.

Although not shown, the computing platform 900 may additionally include or have an interface for connecting to one or more user-interface components that facilitate user interaction with the computing platform 900, such as a keyboard, a mouse, a trackpad, a display screen, a touch-sensitive interface, a stylus, a virtual-reality headset, and/or one or more speaker components, among other possibilities.

It should be understood that computing platform 900 is one example of a computing platform that may be used with the examples described herein. Numerous other arrangements are possible and contemplated herein. For instance, other computing systems may include additional components not pictured and/or more or less of the pictured components.

### CONCLUSION

This disclosure makes reference to the accompanying figures and several examples. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

We claim:

1. A computing platform comprising:
at least one processor;
non-transitory computer-readable medium; and
program instructions stored on the non-transitory computer-readable medium that are executable by the at least one processor such that the computing platform is configured to:
receive a request to compute a score for an input data record, the input data record comprising a group of actual parameters that map to a set of features that a trained data science model is configured to receive as input;
partition the set of features into a plurality of global feature groups based on dependencies between the features;
input the group of actual parameters into the trained data science model, wherein the trained data science model comprises an ensemble of decision trees, and wherein:
each individual decision tree in the ensemble is symmetric,
each individual decision tree in the ensemble is configured to receive a respective subset of the features as input, and
within each individual decision tree, internal nodes that are positioned in a same level designate a same splitting criterion based on a same feature selected from the respective subset of features;
for each individual decision tree in the ensemble:
assign each individual feature in the subset of features for the individual decision tree to a corresponding local feature group that is a subset of a given global feature group that includes the individual feature,
identify a respective leaf such that the actual parameters satisfy a series of splitting conditions for edges that connect nodes in a respective path from a root of the individual decision tree to the respective leaf, and
based on the corresponding local feature groups, determine a set of respective individual contribution values for the respective leaf, wherein each of the respective individual contribution values maps to a respective feature found in the respective subset of features of the individual decision tree;
for each individual feature in the set of features, compute a respective overall contribution value based on:
the respective global feature group, and
a sum of the respective individual contribution values that map to that individual feature; and
compute, via the trained data science model, the score for the input data record.

2. The computing platform of claim 1, wherein the program instructions that are executable by the at least one processor comprise program instructions that are executable by the at least one processor such that the computing platform is configured to:
for each individual decision tree in the ensemble, generate a first matrix of weights, wherein each first weight in the first matrix corresponds to a respective subset pair comprising a first subset of the local feature groups and a second subset of the local feature groups.

3. The computing platform of claim 2, wherein the program instructions that are executable by the at least one processor comprise program instructions that are executable by the at least one processor such that the computing platform is configured to:
for each individual decision tree in the ensemble: generate a second matrix of weights and a third matrix of weights, wherein, for each of a plurality of mixed pairs comprising (i) a respective one of the local feature groups and (ii) a respective subset pair, there is a second corresponding weight in the second matrix and a third corresponding weight in the third matrix.

4. The computing platform of claim 1, wherein the program instructions that are executable by the at least one processor comprise program instructions that are executable by the at least one processor such that the computing platform is configured to:
identify at least one reason code for the score based on the respective overall contribution values for the individual features in the set of features; and
transmit the score and the at least one reason code in response to the request.

5. The computing platform of claim 1, wherein the program instructions that are executable by the at least one processor comprise program instructions that are executable by the at least one processor such that the computing platform is configured to:
prior to receiving the request, train the trained data science model against training data that comprises a plurality of training data records.

6. The computing platform of claim 5, wherein determining the set of respective individual contribution values for the respective leaf comprises:
identifying each realizable path from the root of the individual decision tree to each realizable leaf in the individual decision tree, respectively;
for each identified realizable path, computing a respective first probability by dividing a number of the training data records that were scored during the training based on the identified realizable path by a total number of training data records in the training data;
for each identified realizable path, identifying a respective score to be assigned to input data records scored by the identified realizable path;
for each level of the individual decision tree, identifying the same feature on which the same splitting criterion specified by the internal nodes at that level is based;
identifying subsets of the respective subset of features that the individual decision tree is configured to receive as input;
for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree;
for each identified subset of the respective subset of features, computing a sum of the respective first probabilities for each realizable path in the identified subset; and
for each identified subset of the respective subset of features, computing a marginal path expectation by multiplying the respective score for the respective path by the sum for the identified subset.

7. The computing platform of claim 6, wherein the program instructions that are executable by the at least one processor comprise program instructions that are executable by the at least one processor such that the computing platform is configured to:
for each individual decision tree in the ensemble:
generating, based on the identified groups of realizable paths for the respective path and based on the computed marginal path expectations, a vector of sums of marginal path expectations.

8. The computing platform of claim 6, wherein identifying each realizable path from the root of the individual decision tree to each realizable leaf in the individual decision tree, respectively, comprises:
identifying a selected path to be evaluated for realizability;
detecting that a first splitting condition for a first edge in the selected path and a second splitting condition for a second edge in the path contradict each other; and
excluding the selected path from a list of realizable paths.

9. The computing platform of claim 1, wherein determining the set of respective individual contribution values for the respective leaf comprises:
receiving an identifier of a leaf selected from a decision tree in the ensemble; and
based on the identifier of the leaf, determining a set of contribution values to which the identifier maps in a data structure, wherein the determined set of contribution values to which the identifier maps in the data structure is the set of respective individual contribution values.

10. The computing platform of claim 9, wherein the program instructions that are executable by the at least one processor comprise program instructions that are executable by the at least one processor such that the computing platform is configured to:
prior to receiving the request, generate a respective set of contribution values for each leaf in the ensemble of decision trees and populate the data structure with entries that map the leaves in the ensemble of decision trees to the respective sets of contribution values, wherein generating a respective set of contribution values comprises:
identifying each realizable path from the root of the individual decision tree to each realizable leaf in the individual decision tree, respectively;
for each identified realizable path, computing a respective first probability by dividing a number of the training data records that were scored during the training based on the identified realizable path by a total number of training data records in the training data;
for each identified realizable path, identifying a respective score to be assigned to input data records scored by the identified realizable path;
for each level of the individual decision tree, identifying the same feature on which the same splitting criterion specified by the internal nodes at that level is based;
identifying subsets of the respective subset of features that the individual decision tree is configured to receive as input;
for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree;
for each identified subset of the respective subset of features, computing a sum of the respective first probabilities for each realizable path in the identified subset; and
for each identified subset of the respective subset of features, computing a marginal path expectation by multiplying the respective score for the respective path by the sum for the identified subset.

11. The computing platform of claim 4, wherein the at least one reason code comprises a model reason code (MRC) or an adverse action reason code (AARC).

12. A method carried out by a computing platform, the method comprising:
receiving a request to compute a score for an input data record, the input data record comprising a group of actual parameters that map to a set of features that a trained data science model is configured to receive as input;
partitioning the set of features into a plurality of global feature groups based on dependencies between the features;
inputting the group of actual parameters into the trained data science model, wherein the trained data science model comprises an ensemble of decision trees, and wherein:
each individual decision tree in the ensemble is symmetric,
each individual decision tree in the ensemble is configured to receive a respective subset of the features as input, and
within each individual decision tree, internal nodes that are positioned in a same level designate a same splitting criterion based on a same feature selected from the respective subset of features;
for each individual decision tree in the ensemble:
assigning each individual feature in the subset of features for the individual decision tree to a corresponding local feature group that is a subset of a given global feature group that includes the individual feature,
identifying a respective leaf such that the actual parameters satisfy a series of splitting conditions for edges that connect nodes in a respective path from a root of the individual decision tree to the respective leaf, and
based on the corresponding local feature groups, determining a set of respective individual contribution values for the respective leaf, wherein each of the respective individual contribution values maps to a respective feature found in the respective subset of features of the individual decision tree;
for each individual feature in the set of features, computing a respective overall contribution value based on:
the respective global feature group, and
a sum of the respective individual contribution values that map to that individual feature; and
computing, via the trained data science model, the score for the input data record.

13. The method of claim 12, further comprising:
for each individual decision tree in the ensemble, generating a first matrix of weights, wherein each first weight in the first matrix corresponds to a respective subset pair comprising a first subset of the local feature groups and a second subset of the local feature groups.

14. The computing platform of claim 13, further comprising:
for each individual decision tree in the ensemble: generating a second matrix of weights and a third matrix of weights, wherein, for each of a plurality of mixed pairs comprising (i) a respective one of the local feature groups and (ii) a respective subset pair, there is a second corresponding weight in the second matrix and a third corresponding weight in the third matrix.

15. The method of claim 12, further comprising:
identifying at least one reason code for the score based on the respective overall contribution values for the individual features in the set of features; and
transmitting the score and the at least one reason code in response to the request.

16. The method of claim 12, further comprising:
prior to receiving the request, training the trained data science model against training data that comprises a plurality of training data records.

17. The method of claim 16, wherein determining the set of respective individual contribution values for the respective leaf comprises:
identifying each realizable path from the root of the individual decision tree to each realizable leaf in the individual decision tree, respectively;
for each identified realizable path, computing a respective first probability by dividing a number of the training data records that were scored during the training based on the identified realizable path by a total number of training data records in the training data;
for each identified realizable path, identifying a respective score to be assigned to input data records scored by the identified realizable path;
for each level of the individual decision tree, identifying the same feature on which the same splitting criterion specified by the internal nodes at that level is based;
identifying subsets of the respective subset of features that the individual decision tree is configured to receive as input;
for each identified subset of the respective subset of features, identifying a respective group of realizable paths such that, for each level of the individual decision tree in which the same splitting criterion for that level is based on a feature included in the identified subset, the respective path and the realizable paths in the respective group have a same path direction from that level to a next level of the individual decision tree;
for each identified subset of the respective subset of features, computing a sum of the respective first probabilities for each realizable path in the identified subset; and
for each identified subset of the respective subset of features, computing a marginal path expectation by multiplying the respective score for the respective path by the sum for the identified subset.

18. The method of claim 17, further comprising:
for each individual decision tree in the ensemble:
generating, based on the identified groups of realizable paths for the respective path and based on the computed marginal path expectations, a vector of sums of marginal path expectations.

19. The method of claim 17, wherein identifying each realizable path from the root of the individual decision tree to each realizable leaf in the individual decision tree, respectively, comprises:
identifying a selected path to be evaluated for realizability;
detecting that a first splitting condition for a first edge in the selected path and a second splitting condition for a second edge in the path contradict each other; and
excluding the selected path from a list of realizable paths.

20. A non-transitory computer-readable medium, wherein the non-transitory computer-readable medium is provisioned with program instructions that, when executed by at least one processor, cause a computing platform to:
receive a request to compute a score for an input data record, the input data record comprising a group of actual parameters that map to a set of features that a trained data science model is configured to receive as input;
partition the set of features into a plurality of global feature groups based on dependencies between the features;
input the group of actual parameters into the trained data science model, wherein the trained data science model comprises an ensemble of decision trees, and wherein:
each individual decision tree in the ensemble is symmetric,
each individual decision tree in the ensemble is configured to receive a respective subset of the features as input, and
within each individual decision tree, internal nodes that are positioned in a same level designate a same splitting criterion based on a same feature selected from the respective subset of features;
for each individual decision tree in the ensemble:
assign each individual feature in the subset of features for the individual decision tree to a corresponding local feature group that is a subset of a given global feature group that includes the individual feature,
identify a respective leaf such that the actual parameters satisfy a series of splitting conditions for edges that connect nodes in a respective path from a root of the individual decision tree to the respective leaf, and
based on the corresponding local feature groups, determine a set of respective individual contribution values for the respective leaf, wherein each of the respective individual contribution values maps to a respective feature found in the respective subset of features of the individual decision tree;
for each individual feature in the set of features, compute a respective overall contribution value based on:
the respective global feature group, and
a sum of the respective individual contribution values that map to that individual feature; and
compute, via the trained data science model, the score for the input data record.
